(19) United States
(12) Patent Application Publication
(10) Pub. No.: US 2026/0086955 A1
(43) Pub. Date: Mar. 26, 2026

(54) RANDOMIZED AND SAFE CACHE ARCHITECTURE

(71) Applicant: Coresecure Technologies, LLC, Princeton, NJ (US)

(72) Inventors: Ruby B. Lee, Princeton, NJ (US); Guangyuan Hu, Princeton, NJ (US)

(73) Assignee: Coresecure Technologies, LLC, Princeton, NJ (US)

(21) Appl. No.: 19/339,732

(22) Filed: Sep. 25, 2025

Related U.S. Application Data
(60) Provisional application No. 63/698,826, filed on Sep. 25, 2024.

(51) Int. Cl. G06F 12/14; G06F 12/0862; G06F 12/1045; G06F 12/121

(52) U.S. Cl. CPC G06F 12/1416; G06F 12/0862; G06F 12/1045; G06F 12/121; G06F 2212/1052

(57) ABSTRACT

The present disclosure provides a cache architecture comprising a cache memory having a tag storage and a data storage, a miss status holding register (MSHR) configured to track memory requests where each memory request includes a NoFill field, a safe history buffer (SHB) configured to store safe memory addresses and generate cache line fetch requests based on the stored safe memory addresses, and a cache controller configured to prevent cache fills for memory requests having the NoFill field set, send data to a processor without filling the cache memory when the NoFill field is set, and fill the cache memory with cache lines retrieved by the cache line fetch requests generated by the SHB. The cache architecture provides security against cache timing attacks by decorrelating cache fills from actual memory requests while maintaining performance through the safe history buffer mechanism.

### CROSS-REFERENCE TO RELATED APPLICATIONS

This application claims priority to U.S. Provisional Patent Application No. 63/698,826, titled “Random and Safe (RaS) Cache Architecture to Defeat Cache Timing Attacks” and filed Sep. 25, 2024, which is hereby incorporated by reference in its entirety.

### FIELD OF INVENTION

The present disclosure relates to computer cache architectures, and more particularly to a randomized and safe cache architecture that defeats cache timing attacks by decorrelating cache state changes from memory requests through the use of safe address history buffers and randomized cache fills.

### BACKGROUND

Cache memory systems are fundamental components of modern computer architectures, designed to bridge the performance gap between fast processors and slower main memory. By storing frequently accessed data in high-speed cache memory, these systems reduce average memory access times and improve overall system performance. Cache architectures typically employ various policies for determining which data to store, where to place it, and when to replace it, with common approaches including set-associative designs using least recently used (LRU) replacement policies.

However, cache memory systems have become targets for various security attacks that exploit timing variations in cache access patterns. Cache timing attacks leverage the observable differences in access times between cache hits and misses to extract sensitive information from computer systems. These attacks can be broadly categorized into speculative execution attacks and non-speculative side-channel attacks, each exploiting different aspects of cache behavior to leak confidential data.

Speculative execution attacks take advantage of modern processors' ability to execute instructions before it is known whether the instructions should execute or not. This may potentially access unauthorized memory locations during speculative execution. When such speculative accesses modify cache states, attackers can observe these changes through timing measurements to infer sensitive information, even when the speculative execution is later discarded. These attacks have demonstrated the ability to bypass traditional software-based security mechanisms by exploiting microarchitectural features.

Non-speculative cache side-channel attacks exploit predictable patterns in cache behavior during normal program execution. These attacks can be further classified as access-based attacks, where attackers measure their own access times to infer victim behavior, or operation-based attacks, where attackers measure the execution time of victim operations. Both contention-based and reuse-based channels can be exploited, depending on whether the attack relies on cache line evictions or cache line reuse patterns.

Existing defense mechanisms against cache timing attacks have various limitations. Some approaches rely on partitioning cache resources between different security domains, but this requires detailed knowledge of program behavior and can lead to performance degradation and scalability issues. Other defenses focus on randomizing cache mappings or replacement policies, but these often require modifications to standard cache architectures that can increase access latency and power consumption. Additionally, many existing defenses address only specific types of attacks rather than providing comprehensive protection against both speculative and non-speculative cache timing attacks.

The challenge of designing secure cache architectures is further complicated by the need to maintain performance while providing security. Traditional cache designs prioritize performance optimization through predictable behavior, but this predictability is precisely what enables timing attacks. Balancing security requirements with performance considerations remains a significant challenge in the development of secure computer systems.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a cache architecture is provided. The cache architecture comprises a cache memory having a tag storage and a data storage. The cache architecture comprises a miss status holding register (MSHR) configured to track memory requests, each memory request including a NoFill field. The cache architecture comprises a safe history buffer (SHB) configured to store authorized memory addresses and generate cache line fetch requests based on the stored authorized memory addresses. The cache architecture comprises a cache controller configured to prevent cache fills for memory requests having the NoFill field set, send data to a processor without filling the cache memory when the NoFill field is set, and fill the cache memory with cache lines retrieved by the cache line fetch requests generated by the SHB.

According to other aspects of the present disclosure, the cache architecture may include one or more of the following features. The safe history buffer may be further configured to generate a NoFillClear command to clear the NoFill field of an MSHR entry when a cache line fetch request from the SHB matches an address of the MSHR entry. The NoFillClear command may be propagated to a second (e.g., next-level) cache to clear corresponding NoFill fields in second cache entries. The SHB may be configured to randomly select an authorized memory address from the stored authorized memory addresses and generate the cache line fetch request based on a random memory line within a window of memory lines that includes the selected authorized memory address. The window may comprise a configurable number of cache lines aligned to a memory region that includes the selected authorized memory address. The SHB may be configured to generate cache line fetch requests at a constant rate independent of cache miss events. The cache architecture may further comprise a reorder buffer (ROB) configured to mark memory instructions as speculative or authorized, wherein the SHB receives authorized memory addresses from the ROB when memory instructions are marked as authorized. The ROB may be configured to set the NoFill field for speculative memory requests and clear the NoFill field for authorized memory requests. The cache memory may implement a random replacement policy for cache line evictions. The random replacement policy may prevent information leakage through least recently used (LRU) state changes.

According to another aspect of the present disclosure, a method for securing a cache memory system against timing attacks is provided. The method comprises receiving a memory request including an address and a NoFill indicator. The method comprises determining whether the NoFill indicator is set. The method comprises, when the NoFill indicator is set, retrieving data from a memory hierarchy and providing the data to a processor without filling a cache memory. The method comprises storing authorized memory addresses in a safe history buffer (SHB). The method comprises generating randomized cache line fetch requests based on the authorized memory addresses stored in the SHB. The method comprises filling the cache memory with cache lines retrieved by the randomized cache line fetch requests to improve performance while maintaining security. According to other aspects of the present disclosure, the method may include one or more of the following features. The method may further comprise a step of generating a NoFillClear command together with a fetch request from SHB. The method may further comprise a step of clearing the NoFill indicator of the memory request when a fetch request from SHB matches the address of the memory request having the NoFill indicator set. The method may further comprise a step of propagating the NoFillClear command to a second (e.g., next-level) cache to clear corresponding NoFill indicators in the second cache.

The step of generating randomized cache line fetch requests may comprise randomly selecting an authorized memory address from the SHB and selecting a random memory line within a window of memory lines that includes the selected authorized memory address. The window may comprise a configurable number of cache lines aligned to a memory region that includes the selected authorized memory address. The configurable number of cache lines may be determined based on a security requirement for protecting against contention-based and reuse-based cache timing attacks. The step of generating randomized cache line fetch requests may be performed at a constant rate independent of cache miss events. The method may further comprise a step of marking memory instructions as speculative or authorized using a reorder buffer, wherein only authorized memory addresses are stored in the SHB. The method may further comprise a step of implementing a random replacement policy for cache line evictions to prevent information leakage through cache replacement state changes.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a processor and cache architecture with a safe history buffer, according to aspects of the present disclosure.

FIG. 2 illustrates a block diagram of a processor pipeline and LID cache architecture, according to aspects of the present disclosure for handling of normal requests (NoFill=0).

FIG. 3 illustrates a block diagram of the processor pipeline and LID cache architecture of FIG. 2, for handling of no-fill requests (NoFill=1) to prevent security-sensitive cache fills.

FIG. 4 illustrates a safe history buffer having FIFO-like SHB insertion and random SHB entry selection for SHBfetch, according to aspects of the present disclosure.

FIG. 5 illustrates a block diagram of the processor pipeline and LID cache architecture of FIG. 2, highlighting a SHBfetch request and NoFillClear signal to allow secure cache fills.

FIG. 6 illustrates a sequence diagram showing timing of events for a load instruction with cache miss, according to aspects of the present disclosure.

FIG. 7 is a table showing configurations of simulated systems in GEM5.

FIGS. 8A-8F are graphs showing attacker's measurement in a flush-reload (8A-8C) or prime-probe (8D-8F) Spectre v1 attack. The secret value is 30.

FIGS. 9A-9B are plots showing an attacker's measurements in a prime-probe side-channel attack on AES for baseline (9A) and RaS+ (9B) configurations. The key byte is 0, and the lighter pixels stand for longer access times while darker pixels stand for shorter access times.

FIGS. 9C-9D are plots showing an attacker's measurements in a flush-reload side-channel attack on AES for baseline (9C) and RaS+ (9D) configurations. The key byte is 0, and the lighter pixels stand for longer access times while darker pixels stand for shorter access times.

FIGS. 9E-9H are graphs showing an attacker's measurements in side-channel attack runs in Baseline and RaS+ configurations, including Evict Time in a Baseline configuration (9E) and RaS+W16 configuration (9F), and Cache Collisions in the Baseline (9G) and RaS+W16 configuration (9H)

FIG. 10 illustrates a graph showing Pearson correlation coefficients for different cache side-channel attacks in RaS+ configurations with different window sizes, according to aspects of the present disclosure.

FIG. 11 shows pseudo-code to evaluate whether a 1D array gives an expected pattern.

FIG. 12 shows an example of a successful evict-time attack where the attacker's observation is similar to the expected pattern; the security metrics give a high Pearson correlation coefficient and a low p-value.

FIG. 13 shows pseudo-code to compute security metrics for a 2D pattern.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

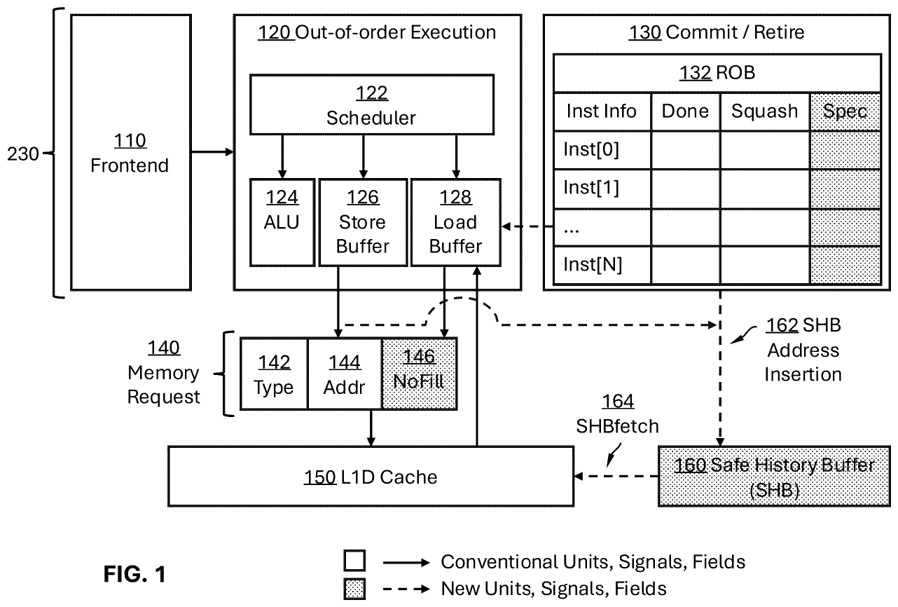

Referring to FIG. 1, a cache architecture may be implemented to address cache timing attacks through a randomized and safe (RaS) approach that decorrelates cache fills from memory requests. The architecture includes a frontend module 110 that handles instruction fetch and decode operations within a processor pipeline 230. An out-of-order execution module 120 connects to the frontend module 110 and manages the execution of instructions in a non-sequential order to improve performance. The out-of-order execution module 120 includes a scheduler 122 that determines when instructions may be executed based on resource availability and data dependencies. An arithmetic logic unit 124 within the out-of-order execution module 120 performs computational operations on data operands. A store buffer 126 temporarily holds store operations before the store operations are committed to memory, while a load buffer 128 manages load operations that retrieve data from memory locations.

The architecture further includes a commit/retire module 130 that ensures instructions complete in program order and maintain architectural state consistency. A reorder buffer 132 within the commit/retire module 130 tracks instructions through the pipeline and determines when instructions may be safely retired. The reorder buffer 132 may mark memory instructions as speculative or authorized based on whether all previous instructions have completed execution without faults. A memory request 140 may include a type identifier 142 that categorizes the nature of memory requests, an address identifier 144 that specifies target memory locations, and a Fill or NoFill indicator 146. The memory request 140 is sent to a cache memory 150 to handle memory access operations.

As further shown in FIG. 1, a safe history buffer 160 connects to the cache memory 150 and implements mechanisms to store authorized memory addresses and generate cache line fetch requests. The safe history buffer 160 includes an address insertion module 162 that receives authorized memory addresses from the reorder buffer 132 when memory instructions transition from speculative to authorized status. A fetch buffer 164 within the safe history buffer 160 generates randomized cache line fetch requests based on the stored authorized addresses. The safe history buffer 160 operates independently from demand-fetch memory requests to decorrelate cache fills from program memory access patterns. In some cases, the safe history buffer 160 may randomly select authorized memory addresses and generate cache line fetch requests for memory lines within configurable windows around the selected addresses.

The cache architecture may implement different operational variants to address various types of cache timing attacks. In some cases, implementations of the presently disclosed techniques may be configured to defeat cache-based speculative execution attacks by preventing speculative memory requests from filling cache lines while allowing authorized memory requests to proceed normally. Some implementations may mark speculative loads with no-fill indicators while permitting non-speculative loads and stores to fill the cache memory 150. Alternatively, some implementations may provide broader protection against both speculative and non-speculative cache timing attacks by marking all memory requests as no-fill and relying entirely on the safe history buffer 160 for cache fills. Some implementations may generate randomized cache line fetch requests at constant rates independent of cache miss events to prevent attackers from correlating cache state changes with victim program behavior. Both variants may utilize random replacement policies within the cache memory 150 to prevent information leakage through cache replacement state observations.

When discussing whether a memory request or other load is safe or unsafe, the term “safe” generally refers to a load that is authorized, non-secret, and/or no longer speculative. “unsafe” therefore, refers to memory requests that are unauthorized (or not yet authorized), secret, or speculative. The address of a memory request is said to be secret if it contains, or leads to, security-sensitive or privacy-sensitive information.

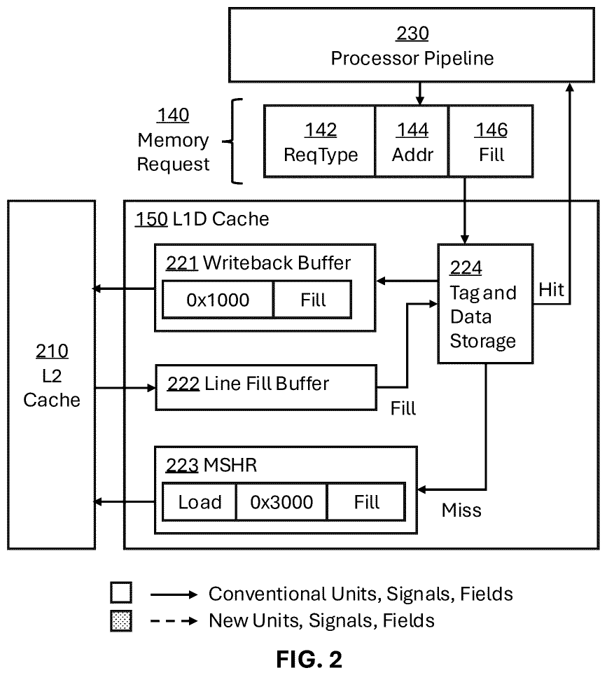

Referring to FIG. 2, the cache memory may include tag storage and data storage components that work together to store and retrieve memory data. The tag storage may contain address tags that identify which memory addresses are currently stored in the cache, while the data storage may hold the actual data values corresponding to those addresses. The cache memory may be implemented as a set-associative structure where memory addresses map to specific cache sets, and each set may contain multiple cache ways for storing different memory lines. In some cases, the cache memory may implement a random replacement policy for cache line evictions, where cache lines are selected for replacement using random selection rather than deterministic algorithms such as least recently used (LRU) policies. The random replacement policy may prevent information leakage through LRU state changes by eliminating predictable patterns that attackers could exploit to infer memory access behaviors.

The cache architecture may include multiple cache levels to provide hierarchical memory storage with different performance and capacity characteristics. As shown in FIG. 2, an LID cache 150 may serve as a first-level data cache that provides fast access to recently used data, while an L2 cache 210 may function as a second-level cache with larger capacity but higher access latency. In some cases, the cache architecture may also include an LII cache for instruction storage, creating a multi-level cache hierarchy where the NoFill mechanism propagates across all cache levels. The propagation of NoFill indicators across cache levels may ensure that security-sensitive memory requests do not fill cache lines at any level of the memory hierarchy, thereby preventing attackers from observing cache state changes at different cache levels.

With continued reference to FIG. 2, the cache memory may include a writeback buffer 221 to handle dirty cache lines that need to be written back to memory when cache lines are evicted or replaced. The writeback buffer may temporarily store modified cache lines before the modified cache lines are written to the next level of the memory hierarchy, allowing the cache to continue processing new memory requests while writeback operations proceed in parallel. In some cases, the writeback buffer may also include NoFill indicators to prevent writebacks of security-sensitive data from filling cache lines at lower levels of the memory hierarchy. The cache memory may further include a line fill buffer 222 to temporarily hold cache lines retrieved from memory before the cache lines are filled into the tag storage and data storage components. The line fill buffer may serve as an intermediate storage location where retrieved cache lines await placement into the appropriate cache sets and ways within the cache memory structure.

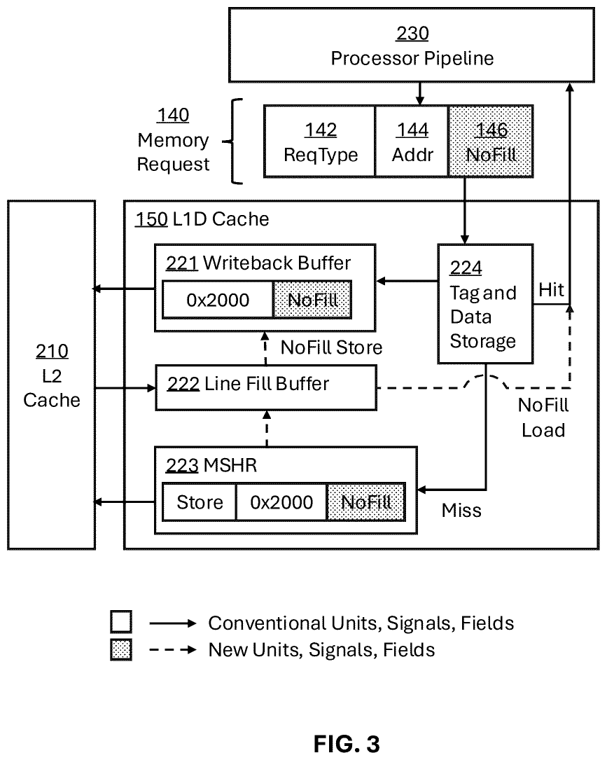

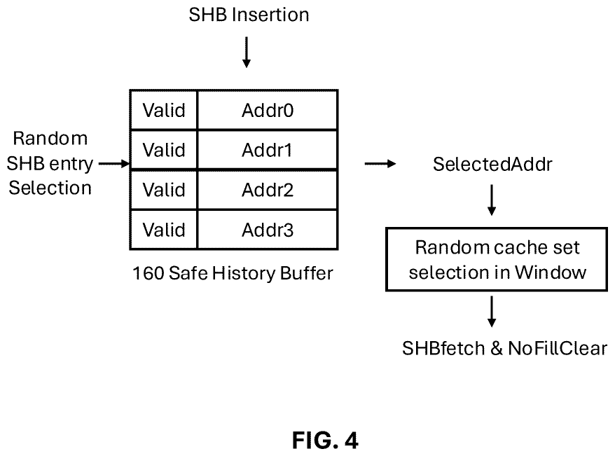

As further shown in FIG. 3 and FIG. 4, the cache memory may implement different handling mechanisms for normal memory requests versus no-fill memory requests. For normal memory requests, as illustrated in FIG. 3, cache hits may return data directly from the tag and data storage, while cache misses may allocate entries in a miss status holding register (MSHR) 223 to track pending memory requests. MSHR 223 is used to represent any type of pending memory requests tracker. For example, MSHR may be used to represent any non-blocking-cache structure for tracking outstanding misses. When requested cache lines return from lower levels of the memory hierarchy, the cache lines may be placed in the line fill buffer and subsequently filled into the tag and data storage 224 through a fill path. For no-fill memory requests, as shown in FIG. 4, the cache memory may handle requests differently by providing data to the processor without filling the cache memory when NoFill indicators are set. The cache memory may utilize the same tag and data storage components for both normal and no-fill requests, but the fill behavior may be controlled by the NoFill indicators associated with each memory request.

The random replacement policy implemented by the cache memory may operate independently of memory access patterns and program behavior, making cache replacement decisions unpredictable to potential attackers. Unlike deterministic replacement policies that maintain state information about cache line usage patterns, the random replacement policy may select cache lines for eviction using random number generation or pseudo-random algorithms that do not correlate with memory access sequences. In some cases, the random replacement policy may be applied consistently across all cache sets and ways within the cache memory, ensuring that no cache replacement decisions leak information about which memory addresses have been accessed by programs. The stateless nature of random replacement may eliminate timing channels that could otherwise allow attackers to infer memory access patterns through careful observation of cache replacement behavior.

The miss status holding register (MSHR) may be configured to track memory requests throughout the cache hierarchy and manage the coordination between demand-fetch operations and cache fill behaviors. The MSHR may maintain entries for outstanding memory requests that have missed in the cache, with each entry containing address information, request type data, and status indicators that control how the corresponding cache line will be handled when the cache line returns from lower levels of the memory hierarchy. Each memory request tracked by the MSHR may include a NoFill field that serves as a control mechanism to determine whether the retrieved cache line will be filled into the cache storage or bypassed directly to the requesting processor. The NoFill field may be set based on the security sensitivity of the memory request, with speculative memory operations typically receiving no-fill treatment while authorized memory operations may be permitted to fill the cache normally.

The MSHR may implement different handling mechanisms for normal memory requests versus no-fill memory requests, allowing the cache controller to make dynamic decisions about cache fill behavior based on the security context of each memory operation. When a memory request with the NoFill field cleared enters the MSHR, the MSHR may track the request using conventional miss handling procedures where the retrieved cache line will be filled into the tag storage and data storage upon return from the memory hierarchy. Conversely, when a memory request with the NoFill field set enters the MSHR, the MSHR may mark the entry to indicate that the retrieved data should be forwarded directly to the processor without updating the cache contents. The MSHR may coordinate with the cache controller to ensure that no-fill requests receive the requested data while maintaining the existing cache state unchanged, thereby preventing security-sensitive memory accesses from creating observable cache state modifications.

The NoFill field within MSHR entries may be selectively applied based on the speculative nature of memory operations, allowing the cache architecture to implement fine-grained control over which memory requests are permitted to modify cache contents. In some cases, the MSHR may set the NoFill field for speculative loads that have not yet been authorized by the reorder buffer, while clearing the NoFill field for non-speculative loads and stores that have been confirmed as safe to execute. The selective application of NoFill indicators may enable the cache architecture to prevent speculative execution attacks while maintaining performance benefits for authorized memory operations. The MSHR may receive updates from the reorder buffer regarding the authorization status of pending memory requests, allowing the MSHR to modify NoFill field values dynamically as speculative operations transition to authorized status during program execution.

The MSHR may coordinate with cache controllers across multiple cache levels to propagate NoFill status information throughout the memory hierarchy, ensuring consistent security behavior from the first-level caches down to the last-level cache. When a no-fill memory request generates a miss at the first-level cache, the MSHR may forward the request to the second-level cache with the NoFill field preserved, allowing lower-level caches to apply the same no-fill handling to prevent security-sensitive data from filling cache lines at any level of the hierarchy. The propagation of NoFill status may extend to writeback operations, where dirty cache lines associated with no-fill requests may be written back to lower cache levels without filling those caches. The MSHR may maintain coherence between cache levels by ensuring that NoFill indicators are consistently applied across all levels of the memory hierarchy, preventing attackers from observing cache state changes at any level that could reveal information about security-sensitive memory access patterns.

The MSHR may implement mechanisms to clear NoFill fields dynamically when cache line fetch requests from the safe history buffer match addresses of pending no-fill requests, allowing the cache architecture to optimize performance while maintaining security properties. When the safe history buffer generates a cache line fetch request for an address that matches a pending no-fill MSHR entry, the MSHR may receive a NoFillClear command that modifies the NoFill field of the matching entry. The NoFillClear operation may transform a no-fill request into a normal fill request, enabling the retrieved cache line to be filled into the cache storage and providing performance benefits for subsequent accesses to the same memory location. The MSHR may coordinate the NoFillClear operation across multiple cache levels, ensuring that matching MSHR entries at all levels of the hierarchy receive the same NoFill field modifications to maintain consistency in cache fill behavior throughout the memory system.

Referring to FIG. 4, the safe history buffer may be implemented with a FIFO-like insertion policy where new authorized addresses replace older entries within the buffer structure. Referring to FIG. 4, a safe history buffer (SHB) 160 may store authorized memory addresses and generate cache line fetch requests based on the stored addresses. The SHB may implement a first-in-first-out (FIFO) insertion policy where new authorized addresses replace older entries in the buffer. In some cases, the SHB may maintain multiple address entries arranged sequentially, with each new authorized address being inserted at one end while the oldest address may be removed from the opposite end when the buffer reaches capacity. The FIFO-like organization may ensure that the most recently authorized addresses remain available for generating cache line fetch requests while older addresses are gradually cycled out of the buffer.

The SHB may employ random selection mechanisms when choosing addresses for generating cache line fetch requests. Rather than using deterministic selection methods that could create predictable patterns, the SHB may randomly select an entry from among the stored authorized addresses. As shown in FIG. 4, after random selection of an address entry, the SHB may further select a random memory line within a window of memory lines that includes the selected address. The window may comprise a configurable number of cache lines aligned to a memory region containing the selected address. In some cases, the window size may be set to match the total number of cache sets to achieve maximum entropy in the randomization process.

The SHB may be configured with different numbers of address entries to balance storage requirements and performance characteristics. In some cases, the SHB may contain a single entry that stores the most recently authorized address. Alternative configurations may include four entries or sixteen entries, allowing the SHB to maintain a broader selection of addresses for generating cache line fetch requests. The number of entries may affect how long authorized addresses remain available for fetch generation before being replaced by newer addresses. The SHB may include hardware structures to identify high-quality addresses whose adjacent memory regions (or other memory region likely to be connected in some way to the requested address) exhibit increased likelihood of future access patterns, allowing preferential retention of addresses that may lead to improved cache utilization.

With continued reference to FIG. 4, the SHB may generate cache line fetch requests at different issue rates to balance performance and security considerations. The issue rate may be configured to generate requests every three cycles, five cycles, seven cycles, or ten cycles. By maintaining a constant issue rate independent of cache miss events, the SHB may prevent correlation between cache fills and program memory access patterns. The SHB may generate and maintain a sequence of cache fetch addresses where no address repeats within the sequence, enhancing the randomization properties of the fetch generation process.

The window for random address selection may be formed by combining multiple smaller windows centered around different SHB entries. Each smaller window may cover a portion of the address space adjacent to a stored authorized address. By combining these individual windows, the SHB may create a larger effective space that increases the range of potential fetch addresses while maintaining spatial locality relative to the authorized addresses. This composite address space may provide additional flexibility in controlling the trade-off between randomization and locality in the cache line fetch request generation process.

Referring to FIG. 3, a cache controller may be configured to implement multiple operational modes for handling memory requests based on NoFill field status and security considerations. The cache controller may examine incoming memory requests to determine whether NoFill indicators are set, and the cache controller may route data flow accordingly through different processing paths within the cache architecture. When the cache controller receives a memory request with the NoFill field set, the cache controller may prevent cache fills by bypassing the normal fill path that would place retrieved cache lines into tag storage and data storage components. The cache controller may instead direct retrieved data through a no-fill path that delivers data directly to the requesting processor without modifying cache contents. The cache controller may coordinate with MSHR entries to track the status of no-fill requests throughout the memory retrieval process, ensuring that data forwarding occurs without cache state modifications.

The cache controller may implement mechanisms to send data to a processor without filling the cache memory when NoFill fields are set for memory requests. When a no-fill memory request generates a cache miss, the cache controller may allocate an MSHR entry to track the pending request while marking the entry to indicate that the retrieved cache line should bypass normal fill operations. The cache controller may coordinate with line fill buffers to temporarily hold retrieved cache lines before forwarding the cache lines directly to the processor through dedicated no-fill data paths. The cache controller may ensure that no-fill operations maintain data integrity and timing characteristics comparable to normal cache operations while preventing any modifications to cache tag storage or data storage components. In some cases, the cache controller may implement parallel processing capabilities that allow no-fill requests to proceed simultaneously with normal cache operations without interference or performance degradation.

The cache controller may be configured to fill the cache memory with cache lines retrieved by cache line fetch requests generated by the safe history buffer, providing performance benefits while maintaining security properties. The cache controller may receive cache line fetch requests from the safe history buffer at regular intervals, with each request specifying a memory address selected through randomization processes applied to stored authorized addresses. The cache controller may process these cache line fetch requests using normal cache fill procedures, allowing retrieved cache lines to be placed into tag storage and data storage components through standard fill paths. The cache controller may coordinate cache fetch operations with ongoing demand-fetch operations to prevent resource conflicts and maintain cache coherence throughout the memory hierarchy. The cache controller may implement priority mechanisms that balance cache line fetch requests from the safe history buffer with demand-fetch requests from the processor to optimize overall system performance.

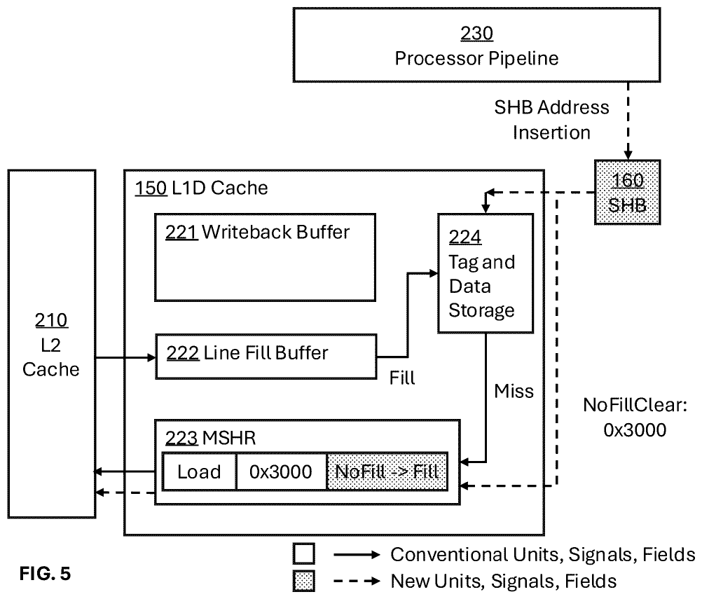

As further shown in FIG. 5, the safe history buffer generates NoFillClear commands and send them to the cache controller. The cache controller compares addresses of incoming cache line fetch requests against addresses stored in MSHR entries that have NoFill fields set, identifying matches that indicate opportunities to convert no-fill requests into normal fill requests. When the cache controller detects an address match between a cache line fetch request and a no-fill MSHR entry, the cache controller may generate a NoFillClear command that targets the specific MSHR entry for NoFill field modification. The cache controller may execute the NoFillClear command by clearing the NoFill field of the matching MSHR entry, thereby enabling the pending memory request to fill the cache normally when the requested cache line returns from the memory hierarchy. The cache controller may coordinate NoFillClear operations with cache line fetch request processing to ensure that both operations proceed without conflicts or timing issues that could affect cache performance or correctness.

The cache controller may implement NoFillClear command propagation mechanisms that extend across multiple cache levels to maintain consistency in cache fill behavior throughout the memory hierarchy. When the cache controller generates a NoFillClear command for a first-level cache MSHR entry, the cache controller may simultaneously propagate the command to second (e.g., next-level) caches that may contain corresponding MSHR entries for the same memory address. The cache controller may coordinate with cache controllers at lower levels of the memory hierarchy to ensure that NoFillClear commands reach all relevant MSHR entries that track the same memory request. The propagation mechanism may prevent situations where a memory request fills the cache at one level while remaining marked as no-fill at other levels, maintaining coherent cache fill behavior across the entire memory system. In some cases, the cache controller may implement acknowledgment protocols that confirm successful NoFillClear command execution at all cache levels before proceeding with cache fill operations.

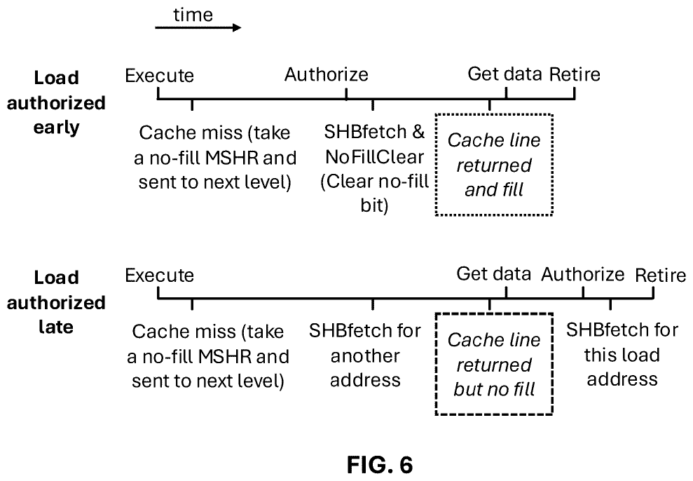

With continued reference to FIG. 6, the cache controller may coordinate the timing of NoFillClear command generation with the authorization status of memory instructions as determined by the reorder buffer. The cache controller may receive authorization notifications from the reorder buffer indicating when speculative memory instructions transition to authorized status, providing timing information that influences NoFillClear command generation. The cache controller may correlate authorization events with pending cache line fetch requests from the safe history buffer to identify optimal timing for NoFillClear command execution. The cache controller may implement early authorization detection mechanisms that allow NoFillClear commands to be generated before requested cache lines return from the memory hierarchy, maximizing the performance benefits of converting no-fill requests to normal fill requests. The cache controller may maintain timing coordination across multiple cache levels to ensure that NoFillClear commands propagate efficiently throughout the memory hierarchy without introducing delays or synchronization issues that could affect overall system performance.

Referring to FIG. 1, a reorder buffer 132 may be configured to track instructions through the processor pipeline and determine the authorization status of memory operations based on the completion state of preceding instructions. The reorder buffer 132 may maintain entries for instructions that have been dispatched for execution but have not yet been retired from the processor pipeline. Each entry within the reorder buffer 132 may contain instruction identification information, execution status indicators, and dependency tracking data that allows the reorder buffer 132 to monitor the progress of instructions through various pipeline stages. The reorder buffer 132 may mark memory instructions as speculative when the memory instructions follow earlier instructions that have not yet completed execution without faults. The reorder buffer 132 may transition memory instructions from speculative to authorized status when all preceding instructions have successfully completed execution, indicating that the memory instructions may be safely executed and committed to architectural state.

The reorder buffer 132 may implement mechanisms to identify when memory instructions become authorized based on the resolution of control flow uncertainties and the completion of dependency chains within the processor pipeline. The reorder buffer 132 may monitor branch prediction outcomes, exception conditions, and fault detection results to determine when speculative execution paths become confirmed as correct program execution sequences. When the reorder buffer 132 determines that a memory instruction no longer depends on unresolved speculative conditions, the reorder buffer 132 may mark the memory instruction as authorized and notify other processor components of the authorization status change. The reorder buffer 132 may coordinate with the load buffer 128 and the store buffer 126 to track the authorization status of pending memory operations, ensuring that authorization notifications reach all components that participate in memory request processing. In some cases, the reorder buffer 132 may implement early authorization detection mechanisms that identify memory instructions as authorized before the memory instructions reach the commit stage of the processor pipeline, allowing performance optimizations to proceed while maintaining correctness guarantees.

The reorder buffer 132 may interface with the safe history buffer 160 to provide authorized memory addresses when memory instructions transition from speculative to authorized status. The reorder buffer 132 may communicate authorization events to the address insertion module 162 within the safe history buffer 160, allowing the safe history buffer 160 to collect addresses from memory operations that have been confirmed as safe for execution. The reorder buffer 132 may provide address information along with authorization notifications, enabling the safe history buffer 160 to store the addresses of authorized memory operations for subsequent use in generating cache line fetch requests. The reorder buffer 132 may coordinate the timing of authorization notifications with the execution status of memory instructions, ensuring that addresses are provided to the safe history buffer 160 at appropriate points in the instruction lifecycle. The reorder buffer 132 may implement filtering mechanisms that determine which types of authorized memory operations should have their addresses forwarded to the safe history buffer 160, allowing selective population of the safe history buffer 160 based on instruction characteristics or system configuration parameters.

With continued reference to FIG. 1, the reorder buffer 132 may coordinate with cache controllers to influence the setting and clearing of NoFill fields based on the authorization status of memory instructions. The reorder buffer 132 may provide authorization status information to the memory request 140, allowing the type identifier 142 to incorporate authorization data when generating memory requests that include NoFill field settings. The reorder buffer 132 may communicate authorization state changes to cache controllers, enabling dynamic modification of NoFill field values as memory instructions progress through different authorization states during pipeline execution. The reorder buffer 132 may implement notification protocols that inform cache controllers when speculative memory instructions become authorized, providing timing information that allows cache controllers to optimize NoFill field management and cache fill operations. In some cases, the reorder buffer 132 may maintain authorization status tracking that persists across multiple pipeline stages, allowing cache controllers to access current authorization information for memory instructions at various points in the memory request processing sequence.

The reorder buffer 132 may implement different authorization criteria for different types of memory operations, allowing fine-grained control over which memory instructions receive speculative versus authorized treatment. The reorder buffer 132 may apply different authorization thresholds for load operations versus store operations, recognizing that store operations typically require stronger guarantees of correctness before being permitted to modify memory state. The reorder buffer 132 may consider instruction dependencies, branch prediction confidence levels, and exception handling status when determining authorization criteria for individual memory instructions. The reorder buffer 132 may coordinate with the scheduler 122 to access dependency information and execution readiness data that influences authorization decisions for memory operations. The reorder buffer 132 may implement configurable authorization policies that allow system software to adjust the criteria used for transitioning memory instructions from speculative to authorized status, providing flexibility in balancing security considerations with performance requirements across different execution environments and workload characteristics.

A method for securing a cache memory system against timing attacks may be implemented to prevent information leakage through cache state observations while maintaining system performance characteristics. The method may begin by receiving a memory request that includes an address specifying a target memory location and a NoFill indicator that controls cache fill behavior for the memory request. The memory request may originate from processor pipeline stages during normal program execution, with the address identifying specific memory locations that programs attempt to access during computation operations. The NoFill indicator may serve as a control mechanism that determines whether retrieved data will be permitted to fill cache storage structures or will be bypassed directly to requesting processor components. The method may process memory requests continuously during program execution, handling both speculative memory operations that have not yet been confirmed as safe and authorized memory operations that have been validated for execution.

The method may proceed by determining whether the NoFill indicator is set for each received memory request, allowing the cache memory system to make dynamic decisions about cache fill behavior based on the security sensitivity of individual memory operations. The determination process may involve examining control fields within memory request structures to identify the current state of NoFill indicators associated with specific memory operations. When the NoFill indicator is set, the method may classify the memory request as security-sensitive and route the memory request through processing paths that prevent cache state modifications. When the NoFill indicator is cleared, the method may treat the memory request as a normal cache operation that may proceed through standard cache fill procedures. The determination process may occur at multiple levels within the cache hierarchy, allowing different cache levels to make independent decisions about cache fill behavior based on NoFill indicator status.

When the NoFill indicator is set, the method may retrieve data from a memory hierarchy and provide the data to a processor without filling a cache memory, thereby preventing security-sensitive memory accesses from creating observable cache state changes. The data retrieval process may involve accessing lower levels of the memory hierarchy to obtain requested data values while bypassing normal cache fill operations that would place retrieved cache lines into cache storage structures. The method may coordinate data forwarding operations to ensure that processors receive requested data with timing characteristics comparable to normal cache operations while preventing cache state modifications. The data provision process may utilize dedicated data paths that deliver retrieved data directly to processor components without updating cache tag storage or cache data storage components. In some cases, the method may implement parallel processing capabilities that allow no-fill data retrieval operations to proceed simultaneously with normal cache operations for other memory requests.

The method may include storing authorized memory addresses in a safe history buffer, creating a repository of memory addresses that have been confirmed as safe for generating cache fill operations. The storage process may involve receiving authorization notifications from processor pipeline components that track the execution status of memory instructions and determine when speculative memory operations transition to authorized status. The method may populate the safe history buffer with addresses from memory operations that have been validated as safe for execution, ensuring that subsequent cache fill operations utilize only addresses that do not compromise system security. The storage process may implement filtering mechanisms that determine which types of authorized memory operations should contribute addresses to the safe history buffer, allowing selective population based on instruction characteristics or system configuration parameters. The method may maintain the safe history buffer using replacement policies that manage buffer capacity while preserving addresses that exhibit favorable characteristics for generating useful cache fill operations.

The method may generate randomized cache line fetch requests based on the authorized memory addresses stored in the safe history buffer, creating cache fill operations that improve performance while maintaining security properties through decorrelation from program memory access patterns. The generation process may involve randomly selecting an authorized memory address from the safe history buffer and selecting a random memory line within a window of memory lines that includes the selected authorized memory address. The window may comprise a configurable number of cache lines aligned to a memory region that includes the selected authorized memory address, allowing the method to balance randomization properties with spatial locality characteristics that influence cache utilization effectiveness. The randomized cache line fetch request generation may decorrelate cache fill timing from program memory access patterns by operating at constant rates independent of cache miss events, preventing attackers from correlating cache state changes with victim program behavior.

The configurable number of cache lines within the randomization window may be determined based on security requirements for protecting against contention-based and reuse-based cache timing attacks, allowing the method to adapt randomization parameters to address specific threat models and attack scenarios. The method may adjust window sizes to provide sufficient randomization entropy to defeat attacks that attempt to observe cache eviction patterns or cache contention behaviors that could reveal information about program memory access sequences. Larger window sizes may provide stronger security guarantees by increasing the randomization space for cache line fetch request generation, while smaller window sizes may preserve spatial locality characteristics that improve cache utilization effectiveness. The method may implement dynamic window size adjustment mechanisms that modify randomization parameters based on detected security threats or system performance requirements. In some cases, the method may set window sizes to match the total number of cache sets to achieve maximum entropy in cache set selection, creating randomized cache behavior that prevents attackers from predicting which cache sets will be affected by cache fill operations.

The method may perform the generation of randomized cache line fetch requests at a constant rate independent of cache miss events, ensuring that cache fill operations occur at predictable intervals that do not correlate with program memory access patterns or cache miss frequencies. The constant rate generation may prevent attackers from inferring information about program behavior by observing the timing or frequency of cache fill operations, as the cache fill rate remains consistent regardless of program memory access characteristics. The method may implement configurable issue rates that determine how frequently randomized cache line fetch requests are generated, allowing system administrators to balance security properties with performance characteristics based on specific deployment requirements. The constant rate approach may decouple cache fill operations from demand-fetch memory requests, preventing correlation between cache state changes and program memory access sequences that could be exploited by timing attack methodologies.

The method may fill the cache memory with cache lines retrieved by the randomized cache line fetch requests to improve performance while maintaining security, allowing the cache memory system to provide performance benefits through cache hits while preventing information leakage through cache state observations. The cache filling process may utilize standard cache allocation procedures to place retrieved cache lines into appropriate cache sets and ways within the cache memory structure, ensuring that randomized cache fills integrate seamlessly with normal cache operations. The method may coordinate randomized cache fill operations with ongoing demand-fetch operations to prevent resource conflicts and maintain cache coherence throughout the memory hierarchy. The cache filling process may implement priority mechanisms that balance randomized cache line fetch requests with demand-fetch requests from processor components, optimizing overall system performance while maintaining security properties. The method may utilize random replacement policies during cache fill operations to prevent information leakage through cache replacement state changes, ensuring that cache line eviction decisions do not reveal information about memory access patterns.

The method may include mechanisms to identify secret-dependent execution and selectively enable or disable the defense based on detection of security-sensitive code, allowing the cache memory system to adapt security measures dynamically based on the characteristics of executing programs. The identification process may involve analyzing program execution patterns, memory access behaviors, or code characteristics to determine when programs are performing operations that could be vulnerable to cache timing attacks. The method may implement detection algorithms that recognize patterns associated with cryptographic operations, security-sensitive computations, or other code sequences that could benefit from enhanced cache security measures. The selective enablement process may allow the method to activate no-fill mechanisms and randomized cache fetch generation only when security-sensitive code is detected, reducing performance overhead during normal program execution while providing protection when needed. In some cases, the method may coordinate with system software or hardware performance monitoring units to identify execution contexts that warrant enhanced cache security measures, allowing dynamic adaptation of security policies based on runtime program characteristics.

The method may include generating a NoFillClear command when a randomized cache line fetch request matches an address of a memory request having the NoFill indicator set, providing a mechanism to optimize cache performance by converting security-sensitive memory requests into normal cache fill operations when safe conditions are detected. The NoFillClear command generation process may involve comparing addresses of incoming randomized cache line fetch requests against addresses stored in miss status holding register entries that have NoFill indicators set to identify potential matches. When the cache memory system detects an address match between a randomized cache line fetch request generated by the safe history buffer and a pending memory request marked with a NoFill indicator, the cache memory system may determine that the memory request address has been authorized and may safely proceed with cache fill operations. The address matching process may utilize hardware comparison circuits that operate in parallel with normal cache request processing to minimize performance impact while identifying optimization opportunities. In some cases, the address matching may consider cache line boundaries and alignment requirements to ensure that NoFillClear commands are generated for appropriate memory request combinations that will benefit from the optimization.

The NoFillClear command generation may incorporate timing considerations that account for the authorization status of memory requests and the availability of cache resources for processing both the randomized cache line fetch request and the pending memory request. The cache memory system may evaluate the current state of memory request processing pipelines to determine optimal timing for NoFillClear command generation, ensuring that the command execution does not interfere with ongoing cache operations or create resource conflicts. The generation process may implement priority mechanisms that balance NoFillClear command processing with other cache management operations, maintaining overall system performance while providing optimization benefits for matched memory requests. The cache memory system may coordinate NoFillClear command generation with the constant-rate generation of randomized cache line fetch requests to ensure that optimization opportunities are identified and processed efficiently throughout program execution. The command generation process may maintain statistical tracking of NoFillClear command frequency and effectiveness to provide feedback for optimizing safe history buffer management and randomized cache line fetch request generation parameters.

The method may include clearing the NoFill indicator of the memory request in response to the NoFillClear command, transforming security-sensitive memory requests into normal cache fill operations when authorization conditions have been satisfied through the randomized cache fetch process. The clearing process may involve modifying control fields within miss status holding register entries to change the NoFill indicator from a set state to a cleared state, enabling subsequent cache fill operations to proceed through normal cache allocation procedures. When the NoFill indicator is cleared, the memory request may transition from a security-sensitive operation that bypasses cache fill mechanisms to a normal cache operation that may place retrieved cache lines into cache storage structures. The clearing operation may occur atomically to prevent race conditions or inconsistent states that could affect cache coherence or data integrity during the transition from no-fill to normal fill behavior. The cache memory system may implement verification mechanisms that confirm successful NoFill indicator clearing before proceeding with cache fill operations, ensuring that the optimization process maintains correctness guarantees throughout the memory request lifecycle.

The NoFill indicator clearing process may coordinate with cache line retrieval operations to ensure that memory requests benefit from the optimization when requested data becomes available from lower levels of the memory hierarchy. When a NoFillClear command clears the NoFill indicator of a pending memory request, the cache memory system may modify the handling procedures for that memory request to enable cache fill operations when the requested cache line returns from memory. The clearing process may update internal tracking structures and control logic to reflect the changed status of the memory request, allowing cache controllers to apply normal fill procedures instead of no-fill bypass operations. The cache memory system may implement rollback mechanisms that can restore NoFill indicator settings if authorization conditions change or if security threats are detected after the clearing operation has been initiated. In some cases, the clearing process may generate confirmation signals that notify other cache management components of the successful NoFill indicator modification, enabling coordinated optimization across multiple cache subsystems.

The method may include propagating the NoFillClear command to a second cache to clear corresponding NoFill indicators in the second cache, ensuring consistent optimization behavior across multiple levels of the cache hierarchy. The propagation process may involve transmitting NoFillClear commands from first-level caches to second-level caches and potentially to additional cache levels that may contain corresponding miss status holding register entries for the same memory address. The command propagation may utilize inter-cache communication protocols that maintain timing coordination and ensure that NoFillClear commands reach all relevant cache levels before cache line retrieval operations complete. The propagation mechanism may implement acknowledgment procedures that confirm successful NoFill indicator clearing at all cache levels before allowing optimized cache fill operations to proceed. The cache memory system may coordinate command propagation with cache coherence protocols to ensure that NoFillClear operations do not interfere with cache line sharing or consistency maintenance across multiple cache levels.

The NoFillClear command propagation may address hierarchical cache structures where memory requests may generate miss status holding register entries at multiple cache levels, requiring coordinated optimization across the entire memory hierarchy. When a memory request misses at the first-level cache and propagates to the second-level cache, both cache levels may maintain miss status holding register entries with NoFill indicators that reflect the security-sensitive nature of the original memory request. The propagation process may ensure that NoFillClear commands modify NoFill indicators at all cache levels that track the same memory request, preventing situations where optimization occurs at some cache levels while security restrictions remain in place at other levels. The command propagation may implement broadcast mechanisms that distribute NoFillClear commands efficiently across multiple cache levels without creating communication bottlenecks or synchronization delays. In some cases, the propagation process may utilize hierarchical command distribution where NoFillClear commands flow through cache levels in a structured manner that maintains ordering and timing relationships between different levels of the memory hierarchy.

The NoFillClear command processing may implement performance monitoring mechanisms that track the effectiveness of the optimization in improving cache utilization and reducing memory access latency for programs executing on the cache memory system. The monitoring process may collect statistics on the frequency of NoFillClear command generation, the success rate of NoFill indicator clearing operations, and the performance benefits achieved through the conversion of no-fill memory requests to normal cache fill operations. The cache memory system may utilize performance feedback to adjust safe history buffer management policies, randomized cache line fetch request generation parameters, and NoFillClear command generation criteria to maximize optimization effectiveness. The monitoring mechanisms may provide visibility into the trade-offs between security properties and performance characteristics, allowing system administrators to evaluate the impact of the NoFillClear optimization on overall system behavior. The performance tracking may identify patterns in NoFillClear command usage that indicate opportunities for further optimization or refinement of the cache security mechanisms.

The method may include marking memory instructions as speculative or authorized using a reorder buffer, providing a mechanism to distinguish between memory operations that have been validated for safe execution and those that remain subject to potential rollback due to unresolved dependencies or speculative conditions. The marking process may involve analyzing the execution state of preceding instructions within the processor pipeline to determine whether memory instructions may proceed without risk of architectural state corruption or security vulnerabilities. The reorder buffer may maintain tracking information for each memory instruction that indicates the current authorization status based on the completion of dependency chains, branch prediction resolution, and exception handling outcomes. The marking process may transition memory instructions from speculative status to authorized status as pipeline conditions change and uncertainty regarding instruction execution outcomes becomes resolved through normal processor operation.

The reorder buffer may implement different criteria for determining when memory instructions transition from speculative to authorized status, allowing fine-grained control over the timing of authorization decisions based on processor pipeline characteristics and security requirements. The authorization process may consider the completion status of all preceding instructions in program order, ensuring that memory instructions receive authorized status only when all earlier instructions have completed execution without generating faults, exceptions, or other conditions that could invalidate the execution sequence. The reorder buffer may evaluate branch prediction outcomes to determine whether memory instructions lie within correctly predicted execution paths, marking memory instructions as authorized only when branch resolution confirms that the memory instructions will be committed to architectural state. The marking process may incorporate exception detection mechanisms that prevent memory instructions from receiving authorized status when earlier instructions generate conditions that could lead to pipeline flushes or execution rollbacks.

The reorder buffer may coordinate with other processor pipeline components to gather information that influences the marking of memory instructions as speculative or authorized, ensuring that authorization decisions reflect the current state of instruction execution across multiple pipeline stages. The reorder buffer may interface with branch prediction units to access confidence information regarding control flow decisions that affect the validity of memory instruction execution paths. The reorder buffer may communicate with exception handling logic to determine whether fault conditions or interrupt events could affect the commitment of memory instructions to architectural state. The reorder buffer may coordinate with cache controllers and memory management units to ensure that authorization decisions account for memory protection violations, translation lookaside buffer misses, or other memory system events that could prevent successful completion of memory operations. The marking process may incorporate feedback from execution units regarding the completion status of arithmetic operations, load operations, and store operations that influence the dependency chains affecting memory instruction authorization.

The method may ensure that only authorized memory addresses are stored in the safe history buffer, creating a repository of memory addresses that have been validated as safe for generating cache fill operations without compromising system security or correctness. The filtering process may examine the authorization status of memory instructions as determined by the reorder buffer marking mechanisms before allowing memory addresses to be inserted into the safe history buffer. The method may implement address insertion policies that accept addresses only from memory instructions that have transitioned to authorized status, preventing speculative memory addresses from contributing to cache fill request generation. The address filtering may operate continuously during program execution, evaluating each memory instruction as the memory instruction progresses through pipeline stages and updating safe history buffer contents based on authorization status changes. The method may coordinate address insertion timing with authorization notification mechanisms to ensure that addresses enter the safe history buffer promptly after memory instructions receive authorized status while preventing premature insertion of addresses from memory instructions that remain speculative.

The method may implement performance monitoring mechanisms that track the effectiveness of memory instruction marking and authorization processes in balancing security properties with system performance characteristics. The performance evaluation may measure the impact of authorization delays on memory access latency, cache utilization efficiency, and overall program execution time across different workload types and processor configurations. The method may collect statistics on the frequency of memory instruction authorization events, the duration of speculative periods for memory operations, and the correlation between authorization timing and cache performance metrics. The monitoring process may evaluate the trade-offs between security guarantees provided by speculative memory instruction filtering and performance overhead introduced by delayed cache fill operations. The method may utilize performance feedback to adjust authorization criteria, safe history buffer management policies, and cache fill request generation parameters to optimize the balance between security protection and system performance across different execution environments and application characteristics.

The method may include implementing a random replacement policy for cache line evictions to prevent information leakage through cache replacement state changes, eliminating predictable patterns in cache line selection that could be exploited by attackers to infer memory access behaviors. The random replacement policy may operate independently of memory access patterns, program execution sequences, and cache line usage histories, making cache replacement decisions unpredictable to potential attackers who attempt to observe cache state changes through timing measurements or other side-channel analysis techniques. The replacement policy may utilize random number generation or pseudo-random algorithms to select cache lines for eviction when cache sets reach capacity and new cache lines require allocation within the cache memory structure. The random selection process may ensure that each cache line within a cache set has equal probability of being selected for replacement, preventing attackers from predicting which cache lines will be evicted based on previous memory access patterns or cache replacement observations.

The random replacement policy may be applied consistently across all cache sets within the cache memory structure, ensuring that no cache replacement decisions leak information about memory access patterns or program behavior characteristics. The policy implementation may maintain statistical uniformity in cache line selection across different cache sets, preventing attackers from identifying cache sets that exhibit predictable replacement patterns that could be correlated with specific memory access sequences. The random replacement mechanism may operate at multiple cache levels within the memory hierarchy, ensuring that replacement decisions at first-level caches, second-level caches, and additional cache levels all utilize random selection criteria that prevent information leakage through replacement state observations. The method may coordinate random replacement operations across cache levels to maintain consistency in replacement behavior while preventing correlation between replacement decisions at different levels of the memory hierarchy that could provide information to attackers.

The random replacement policy may eliminate the maintenance of cache replacement state information that could be exploited by attackers to infer memory access patterns through careful observation of cache timing characteristics. Traditional replacement policies such as least recently used algorithms maintain state information that tracks the usage history of cache lines within each cache set, creating opportunities for attackers to observe state changes that correlate with program memory access behaviors. The random replacement policy may operate without maintaining usage history information, access frequency counters, or temporal ordering data that could provide information about which memory addresses have been accessed by programs executing on the processor. The stateless nature of random replacement may prevent attackers from accumulating information about cache replacement state changes over time, eliminating timing channels that could otherwise allow inference of memory access patterns through sustained observation of cache behavior.

The method may implement random replacement policy mechanisms that balance randomization properties with cache performance characteristics, ensuring that random cache line selection does not significantly degrade cache utilization efficiency or memory access performance. The random replacement implementation may utilize efficient random number generation techniques that provide sufficient entropy for security purposes while minimizing computational overhead associated with replacement decision making. The method may implement pseudo-random algorithms that generate replacement decisions quickly enough to avoid introducing delays in cache allocation operations while providing randomization properties that prevent predictable patterns in cache line selection.

The random replacement policy may coordinate with other cache security mechanisms to provide comprehensive protection against cache timing attacks while maintaining cache performance characteristics that support efficient program execution. The policy may operate in conjunction with no-fill mechanisms and randomized cache line fetch request generation to create multiple layers of protection against different types of cache timing attack methodologies. The random replacement implementation may ensure that cache line eviction decisions do not correlate with the timing of randomized cache line fetch requests generated by the safe history buffer, preventing attackers from observing interactions between different cache security mechanisms that could provide information about program behavior. The method may coordinate random replacement operations with cache coherence protocols to ensure that replacement decisions do not interfere with cache line sharing or consistency maintenance across multiple processor cores or cache levels within the memory hierarchy.

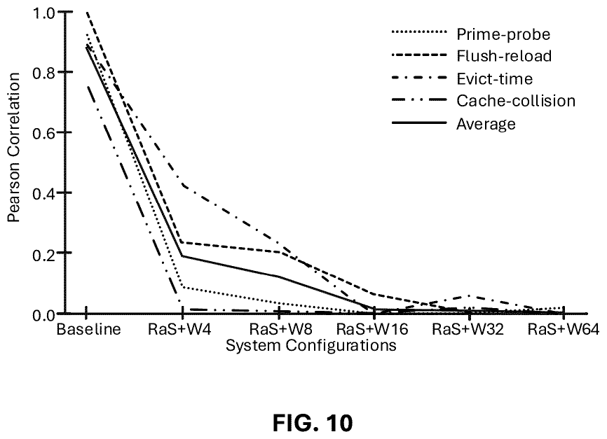

Referring to FIG. 10, the method may implement security evaluation mechanisms that measure the effectiveness of memory instruction marking, random cache fetch and random replacement policy implementation in preventing information leakage through cache state observations. The security evaluation may utilize correlation analysis techniques to assess whether cache timing measurements exhibit patterns that could be exploited by attackers to infer memory access behaviors or program execution characteristics. The method may generate test scenarios that simulate various types of cache timing attacks to evaluate the protection provided by the combination of speculative memory instruction filtering, random cache fetch and random replacement policy implementation. The security assessment may measure correlation coefficients between expected attack patterns and observed cache timing behaviors to quantify the effectiveness of the security mechanisms in preventing information leakage. The evaluation process may provide feedback for adjusting memory instruction authorization criteria, random cache fetch and random replacement policy parameters, and other cache security mechanisms to optimize protection against different types of timing attack methodologies while maintaining acceptable system performance characteristics.

### Variations

Using a high-quality address to generate fetch requests can improve performance. A FIFO design does not differentiate between high-quality and low-quality addresses but attempts to retain high-quality addresses by maintaining multiple entries.

Implementations of the disclosed design can incorporate hardware structures designed to identify high-quality addresses. For example, the hardware structures could be running one or more predictive algorithms, such as a large language model (LLM) or other artificial intelligence model. In some implementations, Artificial Intelligence (AI) models can be trained to retain the high-quality addresses.

In some implementations, the systems may leverage heuristics used in hardware pre-fetchers and adapt them for authorized addresses. For example, the hardware could track the access frequency of different memory regions. In some implementations, some pre-fetching may be accomplished via a predictive algorithm (such as an LLM) or other artificial intelligence model.

Addresses in frequently accessed regions are more likely to be high-quality. In addition, designers could implement mechanisms to record whether an authorized address, when used to generate fetches, results in more cache hits. This address could then be retained and exempt from replacement by an enhancement to the FIFO policy to generate more effective fetches. Separately, the security argument for the disclosed system is that the disclosed approach is more secure against cache side-channel attacks if the generated fetches are scattered across a larger window. In a simple approach, one can apply a same large window to every address from SHB for maximum security, which may results in high performance overhead. The overhead is because a larger window can make the fetched addresses less useful. An alternative approach may combine small windows around SHB addresses to form a larger window. If a small window is created for each SHB address and the SHB address is randomly selected, these smaller windows can effectively combine to create a larger one.

This method and other similar window construction methods could provide security while preserving the performance benefits of maintaining smaller windows. Indeed, other ways of associating a set of memory addresses to an authorized address in an SHB entry can also be designed. The fetch could randomly select one of these associated memory addresses to fill the cache. Separately, in some implementations, the design may generate an fetch address when a fetch is to be issued. It is possible for two fetches to be based on the same SHB address and share the same random offset. In this case, the second fetch would have no effect.

Alternate implementations may involve generating and storing a sequence of fetch addresses, which includes a step of ensuring that no address is repeated within the sequence. In some implementations, this could involve a queue-type structure to save the fetch addresses.

As will be understood in the art, there is a large space for exploration regarding the policies to manage the fetch address storage, e.g., how to decide the frequency of inserting new addresses, whether stale addresses should be removed without being issued, and how to maintain the fairness among SHB base addresses, etc.

Separately, in some implementations, the RaS defense is kept enabled, which has the maximum impact on performance.

An alternative design may focus on identifying secret-dependent execution, such as by monitoring memory instructions that access different locations during each execution. When no secret-dependent or security-sensitive code is detected, the defense could be selectively disabled or switched to a smaller window size to improve or optimize performance. Thus, in some implementations, the system may be configured to (a) determine if any secret-dependent or security-sensitive code is present, and (b) activate the RaS defenses when such code is present, and deactivate the RaS defenses when such code is not present.

### Example 1

The present disclosed approach aims to mitigate cache timing attacks, which can include cache side channel attacks, and cache-based speculative execution attacks.

### Cache Side-Channel Attacks

In a cache side-channel attack, a victim accesses an address determined by a secret, causing cache fills and replacements. The change in the cache state gives the attacker different timing measurements, leaking the secret information.

The difference between traditional side-channel attacks and the cache-based speculative execution attacks is that the former does not require speculative execution or out-of-order execution features to succeed.

The first dimension of cache channels is whether the attacker measures the time of his accesses, the operation time of the victim, or the LRU replacement state. The second dimension is whether the attack is contention-based or reuse-based. The third dimension is whether the attack is speculative or non-speculative. Access-based attackers typically require three steps to (1) prepare initial states, (2) let the victim execute, and (3) measure the final states with the attacker's accesses. The contention-based prime probe attacker first accesses a set of addresses to fill the cache (priming). After the victim's execution, the attacker re-accesses the same set of addresses and observes a longer access time for cache sets that the victim evicts.

The reuse-based flush-reload attack requires shared memory with the victim. The attacker first flushes shared addresses from the cache. After the victim's execution, the attacker re-accesses the shared addresses and observes a shorter reload time for addresses the victim has accessed. The flush-flush attack is also a reuse-based attack where the attacker tries to observe longer flush time for addresses the victim has accessed.

Operation-based attackers measure the victim's secret-dependent execution time. Examples of operation-based attacks are the contention-based evict-time attack and the reuse-based cache collision attack. In the evict-time attack, a cache set is evicted before the victim's execution. The eviction can be caused by either the attacker or the victim itself. Certain secret values will cause the victim to use an evicted cache line, making the execution time longer. In a cache collision attack, the victim accesses an address and brings the cache line into the cache. Certain secret values lead to a later memory access to the same cache line, and the cache line is reused, making the execution time shorter. A cache collision attack is always within the victim's domain and cannot be mitigated by partitioning-based defenses.

Attacks on LRU states can also leak secrets. Depending on the secret, the victim may or may not access a preloaded cache line. The victim's access can modify the LRU state even if it has a cache hit and no new cache line is brought in. The cache line accessed by the victim can remain in the cache as it is “most recently used”, which can be noticed by the attacker as a cache hit.

### Speculative Execution Attacks

Speculative execution attacks are microarchitectural attacks that leak a secret even if proper permission check is enforced. The attacker exploits various hardware vulnerabilities to trigger malicious speculative execution of the sender code. The sender code transiently bypasses the access permission check, performs an illegal access to a secret and transmits it through a microarchitectural covert channel (covert sending). The secret in architectural registers will be cleared when the access is found to be illegal. However, the microarchitectural state change is not backed out of, which can be measured by the attacker (i.e., the receiver).

Speculative execution attacks have six common attack steps: (1) Setup the hardware state to trigger speculative execution and Setup the initial covert channel state. (2) Authorize operation, which enforces software security but gets delayed and bypassed. (3) Access of a secret which is speculative and unauthorized. (4) Use of the secret for covert sending. (5) Send through a covert channel by modifying the microarchitectural state. (6) Receive operation to measure the microarchitectural state and deduce the secret.

A Spectre v1 attack mistrains the prediction for a conditional branch to transiently read a secret even if x is larger than array_size. The secret is then sent through the flush-reload cache channel.

While various microarchitectural states can be used for covert sending, e.g., execution ports, MSHR and branch predictor states, the cache state is still the most important unit to protect against speculative execution attacks because the cache state (1) has a clear timing difference (2) can be measured after the execution (3) has high complexity to clear.

The speculative execution attacks so far have been exploiting the access-based channel in our characterization of cache attacks. The operation-based channel has not been defined for speculative execution attacks, since it takes longer than the speculation window.

### RaS Architecture

A key insight disclosed herein is that filling the cache with deterministic cache line insertions and evictions is the primary source of information leaks in cache timing attacks. Hence, Randomized and Safe (RaS) architecture is disclosed that changes the fundamental fetch and placement policy of cache so that an attacker's observations of the cache state are independent of the addresses of demand-fetch memory requests (executed by a victim or a sender).

To achieve this goal, two mechanisms are implemented. First, security-sensitive cache fills are prevented. Second, an independent cache fill mechanism is implemented using a Safe History Buffer (SHB) to generate randomized cache prefetch requests based on authorized (non-speculative) addresses. FIG. 1 shows a block diagram of RaS with new RaS features colored in gray.

### Preventing Security-Sensitive Cache Fills

Security-sensitive memory requests are prevented from filling any cache level by attaching a NoFill to each request. This bit propagates from the request through the Miss Status Handling Register (MSHR) entry and subsequently to the second (e.g., lower level) caches.

First, MSHR and Line Fill Buffers are clarified when the cache handles a normal or unprotected memory load request with the NoFill bit unset (see FIG. 2). On a normal cache hit, the cache returns the requested data. On a cache miss, an MSHR entry in the cache saves the information of the missing memory request. When the requested cache line is returned from the next level of cache or memory, the cache line is placed in a buffer called the line fill buffer and then filled into the tag and data storage (the Fill path). On a normal writeback when a dirty cache line is replaced, it will enter the writeback buffer to write back the new result.

This can be compared to the modified handling of a no-fill memory request (see FIG. 3). Handling of a no-fill load and store hit is the same as a normal cache hit. On a cache miss for a no-fill load, a no-fill MSHR entry is allocated to save the information of the missing memory request. When the requested cache line is returned from the next level of cache or memory, the cache line is placed in the line fill buffer. As the NoFill bit of the corresponding MSHR is set, the requested data is directly sent to the processor (the NoFill path), but the cache line will not fill into the cache. The no-fill handling is also implemented in the L2 cache.

Referring to FIG. 3, on a cache miss for a no-fill store, a no-fill MSHR entry is allocated and the requested cache line is first placed in the line fill buffer 222. The store data is then written to the line fill buffer 222 for this no-fill store, and the dirty cache line then enters the writeback buffer 221 as a no-fill writeback.

Prevent new writeback attack. As described, the cache line accessed by a no-fill store does not fill the LID cache but is written back to the L2 cache. If the L2 cache allocates a cache line for this writeback, this cache line will be detectable as an L2 hit by the attacker in a new L2 cache timing attack. This new writeback attack can be defeated by propagating a NoFill bit to cache line writebacks so that the L2 cache will not be filled either.

### Generating Decorrelated Cache Fills

Disallowing cache fills prevents cache-based attacks but also eliminates the benefit of future cache hits. An approach was evaluated that just disallows speculative cache fills and found that this increased the average execution time by 226.3% compared to the unprotected baseline. The proposed architecture significantly improves the performance with a decoupled cache fill mechanism described below.

An independent cache fill mechanism is shown to fill the cache with safe and useful lines that will result in future cache hits. A safe address is defined as a non-speculative load or store address. A speculative memory address becomes non-speculative (authorized) when all previous instructions have finished execution without a fault. This authorization can happen before an instruction is committed. We introduce the Safe History Buffer (SHB), which collects safe addresses during program execution and generates prefetch-type requests called SHBfetch to enable cache hits and improve performance while maintaining cache security.

Two key operations are associated with an SHB: how it is populated with safe addresses and how it generates a memory request to fill a safe cache line into the cache.

Inserting Safe Addresses into the Safe History Buffer. To identify non-speculative (authorized) memory loads, the reorder buffer (ROB), which tracks the instructions in the pipeline, is modified to mark each instruction as speculative or not (see FIG. 1). When a memory access is authorized, its address can be inserted into the SHB. A memory store is always sent to the cache after the store instruction is committed, so we could insert a store address into SHB when the store request enters the cache.

Using the Safe History Buffer. Below describes how the prefetch-type SHBfetch requests are generated. With the following mechanisms, one decorrelates what addresses one selects to fill the cache, where the cache eviction occurs, and when the cache is filled.
(1) Random Line in Window for SHBfetch. Using authorized addresses for SHBfetch prevents speculative execution attacks; however, fetching the original authorized address remains vulnerable to side-channel attacks. In a non-speculative side-channel attack, all addresses in the victim program could become SHB entries. Issuing SHBfetch to these same addresses can still leak sensitive information. Therefore, instead of fetching the original authorized address, a random address is fetched near it to mitigate this risk.

FIG. 4 shows one possible SHB implementation that was used in this example. First, if there are multiple SHB entries, an SHB entry is randomly selected. Then, a random memory line is selected from a window of memory lines that includes the selected SHB address. The example defines the window of W lines as aligned to the W-line memory region, including the selected SHB address. Filling a different cache line than the demand fetch address decorrelates both cache reuses and evictions in side-channel attacks.
(2) Constant-rate SHBfetch. One of the more unusual aspects of the disclosed RaS architecture is how one decorrelates when cache fills happen, from when cache misses happen. it is proposed to issue SHBfetch at a constant rate. When all the demand-fetch requests are made no-fill, the constant-rate SHBfetch decouples the number of cache evictions from the victim's accesses, preventing new attacks.
(3) Random Replacement. The random replacement policy is stateless, preventing information leak through LRU state. With benchmarks comparing a set-associative cache with LRU replacement (SA-LRU) versus random replacement (SA-RR) for both L1D and L2 caches, The average overhead is negligible (0.3%).

### SHBfetch and NoFillClear: Allowing Safe Cache Fills

The introduction of the handling of SHBfetch and a performance optimization feature called NoFillClear which can improve the performance by clearing the NoFill bit and allowing safe cache fills.

As shown in FIG. 5, when an SHBfetch enters the cache, it first checks if the address is already in the Tag/Data Storage. If the address is found, the SHBfetch request requires no further action. If the address is not found, the SHBfetch request is inserted into MSHR as a new memory request with the NoFill bit cleared.

SHB also generates a NoFillClear command that has the same address as SHBfetch. NoFillClear is a low-cost operation that only checks the MSHR. If a no-fill MSHR entry with the same cache line address is found, NoFillClear clears the NoFill bit of the entry.

FIG. 5 shows an example of clearing the NoFill bit of the MSHR of address 0x3000 with NoFillClear. The NoFillClear signal/command is also sent to the L2-MSHR, clearing the NoFill bit for any matching entry.

### Example 2—RaS-Spec Against Speculative Cache Attacks

The RaS approach is first used to design RaS-Spec, a defense against cache-based speculative execution attacks. Here, RaS-Spec is introduced and its performance impact is evaluated. RaS-Spec achieves a low performance overhead of 3.8% with a fixed window size of 4 cache lines and can even reduce the average execution time by 0.7% if an optimal window size can be set for each benchmark.

Cache-based speculative execution attacks are covered using the access-based contention or reuse channels. All known speculative execution attacks are considered, including those caused by branch misprediction (e.g., Spectre v1), memory disambiguation mispredicted to skip store-to-load forwarding (e.g., Spectre SSB) and faults (e.g., Meltdown). A memory instruction becomes authorized (Safe) when all previous instructions have finished execution without a fault. Attacks that exploit cache replacement states are also considered.

RaS-Spec marks all speculative loads as no-fill requests, preventing them from filling new cache lines into the cache. In contrast, stores and non-speculative loads are permitted to fill the cache. Authorized memory request addresses are inserted into the SHB directly from the ROB. When a store address enters the cache, it may or may not be added to the SHB without impacting security. For RaS-Spec, we opt not to insert store addresses into the SHB because stores are already allowed to fill the cache.

FIG. 6 shows two possible scenarios for a speculative load that misses in the cache and is assigned a no-fill MSHR. In the first scenario, the load is authorized early, allowing its address to enter the SHB before the requested cache line is returned. If this load address is selected for SHBfetch, the NoFillClear signal matches the address in the no-fill MSHR. At this point, the NoFill can be cleared because the address has been authorized, making it safe to fill the cache. In this scenario, the load is handled as a normal load and will not cause performance overhead. Later, it is shown that 46.48% of speculative loads causing an LID cache miss in benign benchmarks are authorized before the cache line is returned. In the second scenario, the load is authorized late, meaning the SHBfetch can only fetch and fill the address into the cache at a later time. This delay incurs the overhead of initially preventing the cache fill.

In RaS-Spec, a non-speculative load or store can also clear the NoFill bit of a no-fill MSHR for the same cache line, which triggers a NoFillClear sent to the next cache level.

In speculative interference attacks, speculative instructions change microarchitectural states and affect the timing of non-speculative instructions that are earlier in program order (older) but execute later than the speculative instructions.

Cache-based speculative interference attacks can exploit cache contention or reuse. Contention-based interference attacks speculatively evict a cache line that an older instruction will use, increasing the execution time of the older instruction. Reuse-based interference attacks speculatively fetch a cache line that an older instruction will use, shortening the execution time of the older instruction. RaS defenses defeat these attacks because no speculative cache fill or eviction can occur.

### RaS-Spec Performance

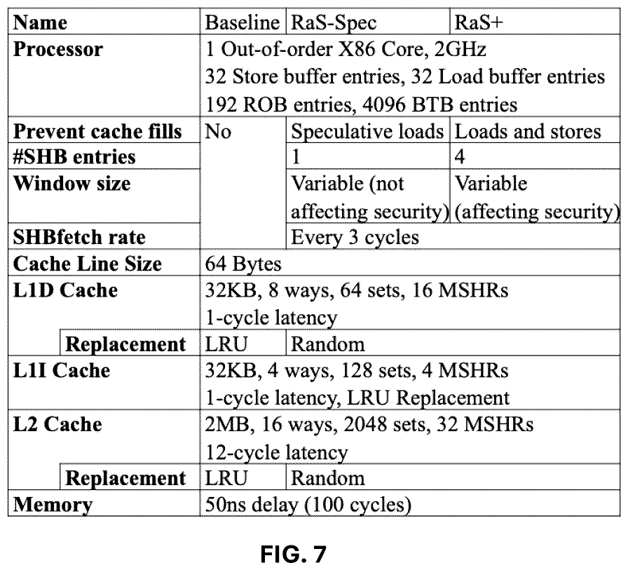

The performance impact of RaS-Spec is evaluated. To get comparable results with other hardware defenses against speculative execution attacks, we use the same GEM5 parameters (FIG. 7), simulation methodology and SPEC2006 benchmarks as used by important defenses like InvisiSpec, CleanupSpec, and MuonTrap. Each benchmark uses the reference data set. The first 10 billion instructions are skipped, and the execution time of running the next 500 million instructions is measured.

RaS architectures can be tuned with three design parameters: issue rate, number of SHB entries and window size (denoted Rx, Ey and Wz). For example, RaS with R3E4W16 means a prefetch rate of an SHBfetch every 3 cycles, a SHB with 4 entries and a window size of 16 cache lines. RaS-Spec can flexibly adjust all parameters for better performance while maintaining security against speculative cache covert channels.

Overall performance. Experiments were run with SHB issue rates of one SHBfetch per 3, 5, 7, and 10 cycles and found that one SHBfetch per 3 cycles gives the best performance for almost all benchmarks. The cache lines prefetched by SHBfetch are useful for later memory accesses, and fetching more lines leads to lower performance overhead.

Different numbers of SHB entries were also tested. Having only one entry (E1), that is, keeping only the most recently authorized address for SHBfetch, performs best for 22 of 24 benchmarks.

RaS-Spec-W1, RaS-Spec-W4 and RaS-Spec-W16 select a random line within a window of 1, 4 and 16 cache lines, respectively. W1 effectively adds no offset to an authorized (“safe”) address, i.e., replays the fetch of the address. W1 increases the average execution time of the baseline configuration by 11.4%. Interestingly, even better performance can be achieved by altering the window size. RaS-Spec-W4 has only a 3.8% average slowdown and RaS-Spec-W16 has an 8.6% average slowdown, both better than RaS-Spec-W1. The result shows that for some benchmarks, fetching randomly selected locations near an authorized address can improve the performance over fetching only the authorized address.

Better performance by choosing best parameters. Benchmarks benefit from different parameters. For example, 9 out of 24 benchmarks have the best performance with W1. 9 other benchmarks have the best performance with W4, and the other 6 benchmarks have the best performance with W16. If one uses the best window configuration for each benchmark, the average normalized execution time of 24 benchmarks will be 99.3%, improving both security and performance (0.7% improvement).

Optimization for No-fill. RaS-Spec achieves low performance overhead by measuring the portion of miss status handling registers (MSHRs) whose no-fill bit is initially set when allocated to a missing demand-fetch access and then gets cleared and allowed to fill the cache.

The no-fill feature prevents speculative execution attacks by not bringing in new cache lines. Unfortunately, it is also the main cause of performance degradation. The performance overhead is reduced with the NoFillClear feature by turning No-fill to Fill (clearing) for cache misses whenever possible, allowing more cache fills. In RaS-Spec, the no-fill bit of the MSHR can be cleared by another demand-fetch access, e.g., a non-speculative load or store, or an SHBfetch. Table 1, below, summarizes the average percentages.

RaS-Spec-W1 only sends the original address of a speculative load that gets authorized. The portion of MSHRs cleared by SHBfetch (46.48% in Table 1, below) shows that nearly half of the speculative loads causing an LID cache miss can be authorized before the cache line is returned (early authorization) so that the NoFill can be turned into a Fill and allowed to fill the cache.

TABLE 1
Average percentages of no-fill MSHRs in RaS-Spec defenses
whose no-fill bit remains uncleared or is cleared.
Portion of No-fill MSHRs (%)

| | L1D | | | L2 | | |
|---|---|---|---|---|---|---|
| | | No-fill bit cleared by | | | No-fill bit cleared by | |
| | Remain | | Non-Spec | Remain | | Non-Spec |
| | No-fill | SHBfetch | Access | No-fill | SHBfetch | Access |
| W1 | 53.16 | 46.48 | 0.36 | 50.43 | 49.17 | 0.40 |
| W4 | 65.33 | 33.75 | 0.92 | 46.66 | 52.83 | 0.51 |
| W16 | 88.00 | 10.90 | 1.10 | 69.49 | 30.00 | 0.51 |

The percentages of MSHRs cleared by SHBfetch in W4 (33.75%) and W16 (10.90%) are lower than W1 because, with a larger window, it is less likely for the original authorized address to be selected for SHBfetch, which clears the NoFill bit. While the portion of cleared MSHRs in W4 is lower than in W1, W4 fetching adjacent lines (or other lines connected ibn some fashion to the requested address) improves performance compared to W1.

In Table 1, the percentage of L2 MSHRs cleared by SHBfetch is always higher than LID MSHRs because the L2 miss latency, i.e., the time taken to access the memory, is high. Hence, it is more likely for a speculative access to be authorized before the requested cache line is returned. The high portion shows that the expensive L2 misses benefit more from NoFillClear compared to LID misses.

Comparison with past work. RaS-Spec is compared with important previous defenses with a similar threat model for cache-based speculative execution attacks, including misprediction, store-to-load forwarding and faults. RaS-Spec-W1 with 11.4% overhead, which also refetches the exact authorized address, has less overhead than the 16.8% slowdown reported for InvisiSpec-Future because RaS-Spec can benefit from sending the authorized address early and clearing the NoFill bit, rather than delaying the fetch of a non-speculative address until the load is returned, as done in InvisiSpec. Moreover, RaS-Spec does not store local copies of data (it only stores addresses), so it does not introduce coherence problems, which cause extra pipeline stalls to wait for data validation.

MuonTrap and GhostMinion have a low average overhead of 4% and 2.5% on SPEC2006 benchmarks, respectively. They require a separate shadow cache structure that stores speculative data and communicates with the original cache system. CleanupSpec, as an undo-type defense, has an overhead of 5.1%. However, it needs to wait for cleanup operations and introduces new attacks. Hence, our RaS-Spec-W4 cache has one of the lowest performance overheads (3.8%) amongst all defenses proposed to defeat cache-based speculative execution attacks, without the complexity to manage and communicate with a shadow cache structure.

### RaS+ Against Speculative and Non-Speculative Cache Attacks

RaS+ is designed to defeat both cache-based speculative execution attacks and traditional non-speculative cache side-channel attacks. The same threat model for speculative execution attacks as RaS-Spec is adopted, and additionally address non-speculative cache side-channel attacks.

For access-based attacks, RaS+ prevents speculative and non-speculative attacks that exploit the contention-based or reuse-based channel.

It is assumed that the attacker can capture the beginning and end of the victim program to launch operation-based attacks. For contention-based operation-based attacks, the contention caused by the attacker's domain or within the victim's domain is considered. The reuse-based operation-based attack is always caused by the victim's behavior, within the victim's domain. Attacks exploiting LRU cache replacement states, which can be speculative or non-speculative, are also defeated.

It is aimed to build a valid defense that does not require the system software to allocate security domains for programs, which is hard without detailed knowledge and raises scalability concerns. It does not rely on security domain information to mitigate attacks.

It is assumed the system software is trusted for protecting registers, if any, which enables the RaS defense or configures RaS parameters.

### RaS+ Design and Security

RaS+ marks all loads and stores as no-fill and prevents them from filling the cache. Authorized memory request addresses are inserted into the SHB directly from the ROB. When a store address enters the cache, it is also added to the SHB. RaS+ decorrelates the memory line filled into the cache from the demand request by randomly selecting an address within a window around an authorized address, effectively adding a random offset.

### Impact of Window Size

The size of the window for random fetching influences RaS+'s security against non-speculative cache side-channel attacks.

Contention-based attacks. RaS+ can mitigate contention-based attacks by ensuring that any cache set within the window is equally likely to be evicted and filled. If RaS+ can cover all secret-dependent cache sets, a contention-based attack is defeated.

Additionally, RaS can achieve guaranteed security for the L1 data cache if RaS+ covers all possible cache sets by setting the window size to the total number of cache sets. In FIG. 7, there are 64 cache sets for the 32 KB 8-way L1 data cache (32 KB/8-way set-associativity/64Byte=64 sets). This configuration allows RaS to implement a randomized L1 cache using a conventional set-associative design. This hardware-dependent window size has the advantage of being automatically determined by the hardware to maximize entropy. As a result, software developers do not have to identify security-critical regions to configure the window size, and existing software can be protected without modification.

Reuse-based attacks. It can also mitigate non-speculative reuse-based attacks if the window covers the security-critical region accessed with a secret-dependent index, meaning every cache line in the region has an equal chance of being fetched. The cache collision attack tries to observe a shorter execution time when the victim will reuse certain secret-dependent addresses in the security-critical region. The flush-reload attacker measures the time it takes to reload each cache line in the security-critical region. Having all such addresses equally likely to be fetched eliminates the timing difference in both cases. If the security-critical region is larger than the window size, random fetches within the window can protect the lower bits of an address but cannot provide absolute security.

### RaS+ Performance.

RaS+ always defeats speculative cache covert channels as the SHBfetch is generated from authorized addresses. The issue rate and the number of SHB entries can be tuned for better performance without affecting security, but the window size affects the level of disturbance against side-channel attacks as discussed.

For the strongest protection against contention-based attacks, one wants SHBfetch to randomly choose among all cache sets. Randomly choosing among 64 sets in the LID cache is equivalent to the random selection of a cache line in a window of 64 cache lines. For best security protection, a large window of W64 was used for initial experiments on the issue rate and SHB entries below. The performance overhead was then evaluated for smaller window sizes.

Issue rate. Experiments with issue rates of one SHBfetch per 3, 5, 7, and 10 cycles were run, and it was found that sending one SHBfetch per 3 cycles has the best performance for all benchmarks.

Number of SHB entries (#SHB). We test SHB with 1, 4 and 16 entries (denoted E1, E4 and E16) while fixing R3 and W64. The interesting finding is that E4 has a lower average performance overhead (45.2%) than E1 (56.0%) and E16 (47.7%). The performance improvement with E4 can be due to the quality of addresses in the SHB. A high-quality address is the address whose adjacent lines (or other lines connected to the requested address) are used in later execution. SHB with one entry can easily lose a high-quality address when the next authorized address is inserted. SHB with more entries can keep a high-quality address longer for prefetching. However, having too many entries in the SHB, e.g., 16, will reduce the chance of using newer addresses for SHBfetch, leading to less useful prefetching. E4 preserves the quality and freshness of addresses for most benchmarks.

Window size. The average overheads of W4, W16 and W64 compared to the Baseline are 7.9%, 18.8% and 45.2%, respectively, as shown by the geometric means. W16 is a choice providing enough security with medium overhead. W64 has a large slowdown but does provide guaranteed security against the contention-based attacks.

Security-performance trade-offs. Increasing the window size can reduce the likelihood of a future cache hit on the selected fetched line, as temporal and spatial locality may be lost over a wider range. Conceptually, a larger window size enhances security by increasing randomness but may result in reduced performance, whereas a smaller window size prioritizes performance at the expense of weaker security guarantees.

Optimization for No-fill. Table 2 shows the percentages of MSHR entries where NoFill can be turned to Fill (cleared) in RaS+. Unlike RaS-Spec, all loads and stores are labeled no-fill in RaS+ and cannot clear the NoFill bit of previous accesses (zeros for columns of Non-Spec Access in Table 2). Similar to RaS-Spec, the percentage of MSHRs with NoFill's cleared to Fill's decreases with a larger window size. Also, no-fill bits of L2 misses in RaS+ are more likely to be cleared by the no-fill optimization than LID misses.

TABLE 2
Average percentages of no-fill MSHRs in RaS+ defenses
whose no-fill bit remains uncleared or is cleared.
Portion of No-fill MSHRs (%)

| | L1D | | | L2 | | |
|---|---|---|---|---|---|---|
| | | No-fill bit cleared by | | | No-fill bit cleared by | |
| | Remain | | Non-Spec | Remain | | Non-Spec |
| | No-fill | SHBfetch | Access | No-fill | SHBfetch | Access |
| W4 | 79.10 | 20.90 | 0.00 | 61.90 | 38.10 | 0.00 |
| W16 | 92.69 | 7.41 | 0.00 | 82.31 | 17.69 | 0.00 |
| W64 | 97.92 | 2.08 | 0.00 | 94.05 | 5.95 | 0.00 |

Performance Comparison with Side-Channel Defenses

RaS+ was designed to mitigate both speculative and non-speculative cache timing attacks while preserving the conventional set-associative cache structure (unlike NewCache with a fully-associative CAM structure), and not requiring security domain information like partitioning defenses. This goal has not been achieved by prior cache defenses. The most closely related defense with similar assumptions is the Random Fill (RF) cache, which targets only cache collision attacks. Here, it is shown that RaS+, which defeats more attacks, has better performance than the RF cache.

Unlike RaS+, the original RF cache protected only the L1 cache but not other cache levels like the L2 cache. The RF cache may generate a prefetch request based on a speculative address, which can lead to successful speculative execution attacks. In contrast, RaS+ generates prefetch requests only based on non-speculative address sites in SHB. Also, the RF cache generates a prefetch request for each cache miss whereas RaS+ issues an SHBfetch at a constant rate, e.g., every 3 cycles, to decorrelate when cache fills happen from when cache misses happen. This can defeat potential attacks that count the number of cache misses caused by the victim program.

For comparison, an RF cache with protection for both L1D and L2 caches was implemented, similar to the implementation of RaS+ caches. It was found that RaS+ consistently outperforms the RF cache at every window size while offering stronger security against more attacks. RF-W4, RF-W16 and RF-W64 have average performance overheads of 26.7% (versus 7.9% in RaS+W4), 49.3% (versus 18.8% in RaS+W16) and 84.5% (versus 45.2% in RaS+W64), respectively.

### Example 3—Security Evaluation

The security of RaS-Spec and RaS+ is evaluated with a suite of representative attacks. The GEM5 simulator is used to implement an unprotected Baseline architecture and RaS defenses. The hardware parameters and defense functionalities are shown in FIG. 7. RaS-Spec and RaS+ are run against a contention-based and a reuse-based Spectre v1 attacks. RaS+ is further run against four different types of cache side-channel attacks on the Advanced Encryption Standard (AES) encryption, covering attack columns of access-based and operation-based. To evaluate the security of RaS+ with different window sizes against side-channel attacks, security metrics are proposed, measured, and computed.

### Spectre v1 Attack

Spectre v1 attacks are run, which use either a flush-reload (reuse-based) or a prime-probe (contention-based) cache channel.

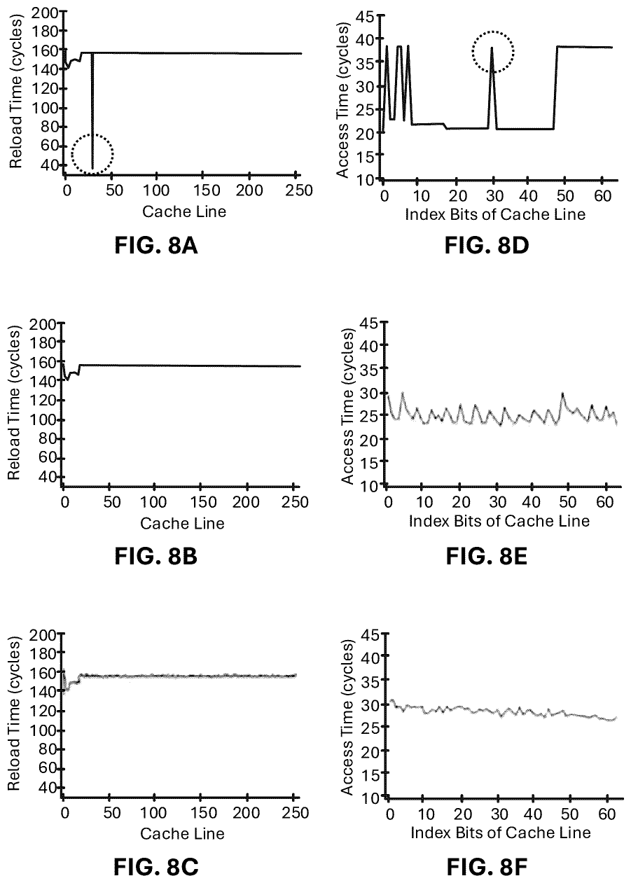

Flush-reload cache channel. FIGS. 8A-8C show the attacker's measurement with or without the defense to recover the secret value of 30. In RaS-Spec and RaS+ systems, the speculative access to shared [30*step] cannot fill the cache.

Prime-probe cache channel. The attacker code tries to fill the cache with his cache lines before the speculative execution (Prime). The sender code tries to evict one attacker's line in a secret-dependent cache set. FIG. 8D shows the secret-dependent eviction happens in the cache set 30 (circled). Some other sets also have high access times caused by unrelated memory accesses. The secret-dependent eviction no longer appears in RaS-Spec (FIG. 8E) and RaS+ (FIG. 8F) systems.

### Cache Side-Channel Attacks on AES

The Advanced Encryption Standard (AES) algorithm is a commonly used standard for data encryption and decryption. The secret key generates an address to read the AES lookup tables. If an attacker can observe the cache hits or misses caused by a victim's AES encryption program, the victim's key can be leaked. Four access-based and operation-based cache side-channel attacks are tested: prime-probe, flush-reload, evict-time and cache collision attacks. All four attacks exploit the first round of an AES-128 encryption program, which reads four AES lookup tables, T₁ to T₄, with the addresses shown below. Dᵢ and Kᵢ are 16 input bytes and key bytes. ⊕ is the XOR operation of two bytes.

$${T}_{1} [ {D}_{1} ⊕ {K}_{1} ] , {T}_{1} [ {D}_{5} ⊕ {K}_{5} ] , {T}_{1} [ {D}_{9} ⊕ {K}_{9} ] , {T}_{1} [ {D}_{13} ⊕ {K}_{13} ]$$

$${T}_{2} [ {D}_{2} ⊕ {K}_{2} ] , {T}_{2} [ {D}_{6} ⊕ {K}_{6} ] , {T}_{2} [ {D}_{10} ⊕ {K}_{10} ] , {T}_{2} [ {D}_{14} ⊕ {K}_{14} ]$$

$${T}_{3} [ {D}_{3} ⊕ {K}_{3} ] , {T}_{3} [ {D}_{7} ⊕ {K}_{7} ] , {T}_{3} [ {D}_{11} ⊕ {K}_{11} ] , {T}_{3} [ {D}_{15} ⊕ {K}_{15} ]$$

$${T}_{4} [ {D}_{4} ⊕ {K}_{4} ] , {T}_{4} [ {D}_{8} ⊕ {K}_{8} ] , {T}_{4} [ {D}_{12} ⊕ {K}_{12} ] , {T}_{4} [ {D}_{16} ⊕ {K}_{16} ]$$

A strong attacker who controls the input data and can accurately capture the victim's execution to do measurements is assumed. The window size is chosen to be 4 kB, which is a multiple of the total number of cache sets and also large enough to cover the AES tables.

Prime-probe attack. A prime-probe attack on the AES encryption does not require shared memory. The attacker fills the cache by reading a big array before the victim's execution and measures the latency to access the addresses that will be mapped to different cache sets.

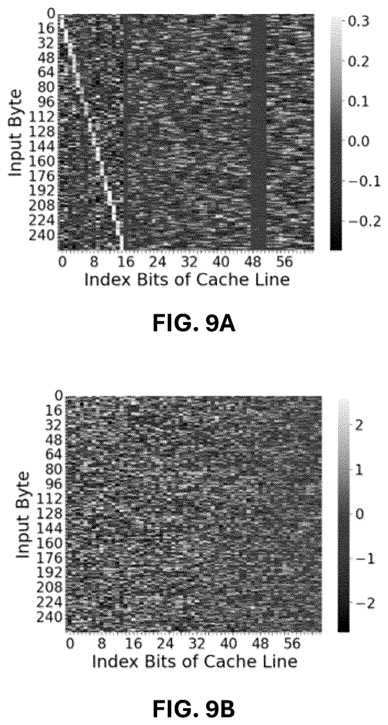

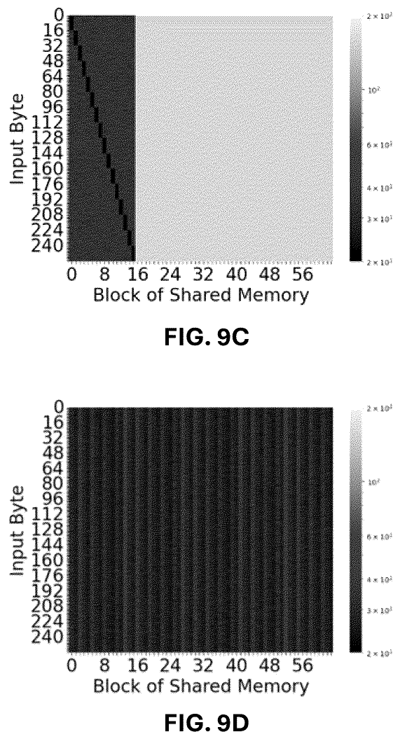

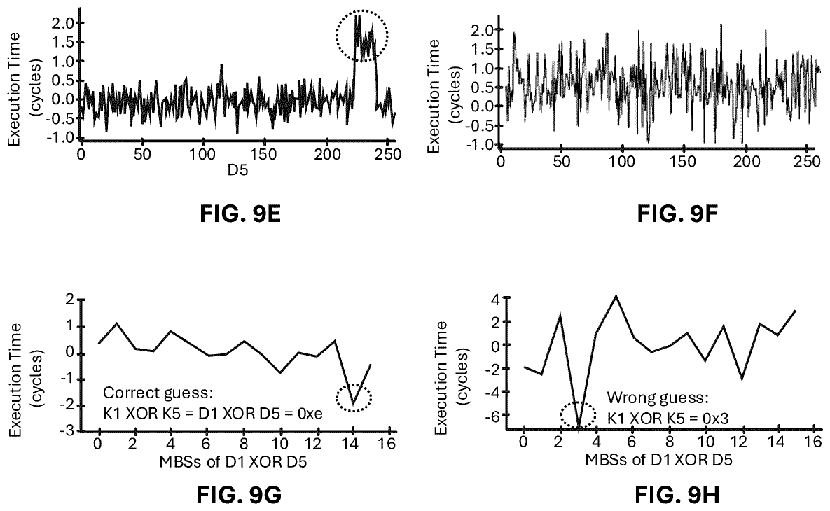

Referring to FIGS. 9A and 9B, in the Baseline system, the attacker can only recover the four Most Significant Bit(s) (MSB(s)) of each key byte, which are also found to be 0x0. The four Least Significant Bit(s) (LSB(s)) of the key byte cannot be determined, as accessing any of the 16 4-byte AES entries in the same cache line can cause the cache line to be fetched. RaS+ can defeat the attack and no meaningful pattern can be found. As the window size is equal to the total number of cache sets, each cache set has an equal chance to be accessed by the SHBfetch and cause an eviction. The defense defeats the prime-probe attack.

Flush-reload attack. A flush-reload attack on an AES program is possible when the AES tables are in a memory region shared by multiple processes, e.g., as a part of a shared library. The attacker measures which cache lines of AES table entries are in the cache, which means the victim uses them.

Referring to FIGS. 9C and 9D, in the Baseline system, one key byte can be partially leaked. The attacker measures a 4 kB region, i.e., 64 cache lines, where the first 1 kB is the AES table T1. With the y-axis being the input byte and the x-axis being the accessed line, the dark diagonal represents the XOR result of the input byte and the key byte. The four MSBs of this key byte can be found to be 0x0. Similar attacks can be repeated for the other 15 key bytes, causing four bits in each key byte to be leaked. RaS+ performs random fetching within the 4 kB shared memory region, which is covered by the window, so every cache line has an equal chance to be fetched. The first 16 lines of the AES table and the other 48 unused lines have similar access latency.

Evict-time attack. Referring to FIGS. 9E and 9F, the example evict-time attack emulates a victim whose code evicts a specific cache set before the AES encryption. If the encryption uses the AES table entries mapped to the evicted set, the execution time will be longer.

FIG. 9E shows the attacker's observation when a cache set containing some entries in the lookup table T₁ is evicted before encryption. Therefore, when the input bytes (such as D1 and D5) are certain values, reading T1 (e.g., T₁[D₁⊕K₁] and T₁[D₅⊕K₅]) will access the evicted cache set and take longer time, also increasing the total execution time.

As a fixed cache set is evicted, the attacker can know D₁⊕K₁=D₅⊕K₅ for D₁ and D₅ with longer execution time. Observing that the long-time D1 values are 0 to 15 (0x0* in hex) and long-time D5 values are 0xe* in hex, the attacker can infer that K₁⊕K₅=0xe*, which is the correct guess when K₁ is 0x0f and K₅ is 0xe6.

RaS+ (FIG. 9F) shows no meaningful longer execution time which can leak the key because the memory accesses in the eviction phase are made no-fill and unable to evict the target set. Some SHBfetches may be generated based on the addresses for eviction. However, the random offsets added to these SHBfetches lead to evictions of random cache sets.

Cache-collision attack. Referring to FIGS. 9G and 9H, the reuse-based cache collision attack on AES observes a shorter execution time when certain input values cause a cache line containing AES table entries to be reused. We emulate a stronger attacker using 1 MSHR entry in the LID cache instead of 16 MSHR entries in FIG. 7. Having fewer MSHR entries reduces the number of accesses other than the target access to cause cache collision, giving the attacker a clearer observation of low execution time.

FIG. 9G shows, for Baseline, a lower execution time due to reuse when accessing the lookup table T₁. When T₁[D₁⊕K₁] and T₁[D₅⊕K₅] access the same cache line (the MSBs of D₁⊕D₅ are equal to the MSBs of K₁⊕K₅), the execution time is shorter. The attacker can learn K₁⊕K₅=0xe* from the figure, which is the correct guess as K₁ is 0x0f and K₅ is 0xe6. FIG. 9H shows, for RaS+, a low execution time at a wrong location. The attacker will have a wrong guess of the key.

Definition of Security Metrics. For security evaluation, the idea is to obtain scores describing the similarity between the patterns the attacker observes and the patterns of an ideal attack. We introduce the algorithm to measure the similarity of one-dimensional (1D) and two-dimensional (2D) patterns using the Pearson correlation coefficient for all attacks.

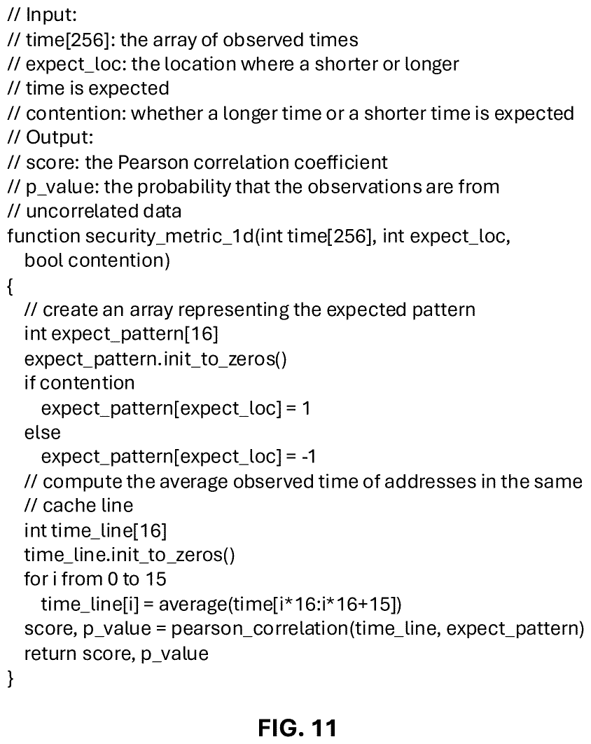

FIG. 11 shows the pseudo-code to evaluate whether a 1D array gives the expected pattern, e.g., in evict-time and cache collision attacks. In cache side-channel attacks, there is usually a secret-dependent cache line where the attacker expects to see a cache hit (reuse) or miss (contention). The algorithm creates an expect_pattern array representing the expected pattern. The expect_pattern array has all zeros and a 1 or −1 at the expected location, depending on whether the attack is contention-based or reuse-based.

Raw measurements are averaged to create a corresponding pattern for comparison from the raw input. In FIG. 11, the raw measurements, i.e., the time array, have 256 entries corresponding to different values of an input byte in AES. As a cache line contains 16 4-byte AES lookup table entries, every 16 consecutive entries in the time array are averaged. The average observation of each cache line is saved in the time_line array.

The last step gives the coefficient (shortened as score) and p-value (p_value) of doing Pearson correlation. The coefficient of two vectors X and Y with the same length n is defined as:

$$score ( X , Y ) = \frac{{\sum }_{i = 1}^{n} ( {X}_{i} - \overline{X} ) ( {Y}_{i} - \overline{Y} )}{\sqrt{{\sum }_{i = 1}^{n} {( {X}_{i} - \overline{X} )}^{2}} \sqrt{{\sum }_{i = 1}^{n} {( {Y}_{i} - \overline{Y} )}^{2}}}$$

X̅ and Y̅ are the arithmetic means of X and Y. The computed coefficient is a number between 1 and −1. A coefficient of 1 means a perfect linear relationship and a successful attack. A coefficient of 0 means no correlation between the two patterns and a defeated or unsuccessful attack. A coefficient of −1 means a perfect negative linear relationship, which is unseen in this scenario.

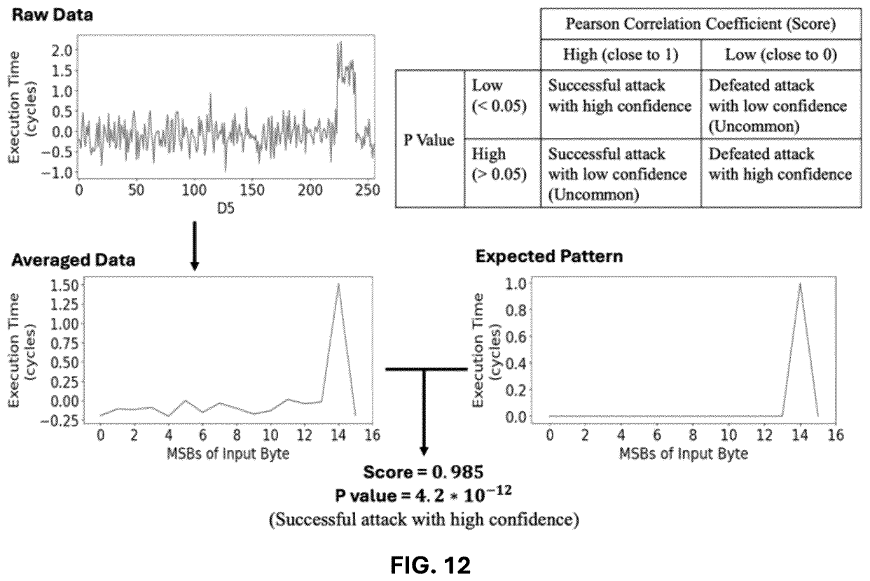

The p-value indicates the statistical significance of the coefficient. The p-value is the probability of obtaining a coefficient at least as extreme as the observed coefficient under the assumption of no correlation. Commonly used thresholds for significance in p-values are 0.05 and 0.01. In FIG. 12, an example is shown that follows the algorithm to compute the security metric and how to interpret the Pearson correlation coefficient and p-value. There are four possible outcomes when computing the coefficient and p-value: a successful attack detected with high confidence, a successful attack with low confidence (uncommon), a defeated attack with high confidence and a defeated attack with low confidence (uncommon).

The uncommon scenarios can be briefly explained. If an experiment produces a low correlation coefficient with a low p-value, it means the observation is neither similar to the expected pattern nor likely to arise from an unrelated pattern, which is unlikely to occur. If an experiment produces a high correlation coefficient and a high p-value, it suggests the observation could be caused by both an attack and an unrelated pattern, which gives two contradictory conclusions. Therefore, both cases are rare to observe. We also did not observe these two cases in our experiments.

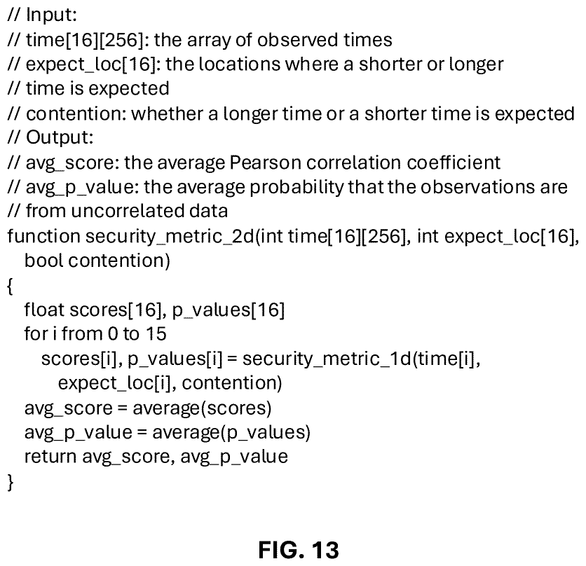

FIG. 13 shows the pseudo-code to compute security metrics for a 2D pattern, such as the results of prime-probe and flush-reload attacks (FIGS. 9A-9D). The algorithm takes a 2D array (time), a list of locations to observe longer or shorter times (expect_loc) and the attack type (contention) as inputs. Each location in the expect_loc list is pre-computed for a column. The algorithm then divides the time array by columns and computes the metrics for all columns. The average score (Pearson correlation coefficient) and p-value computed by Lines 17 and 18 are the overall security metrics of the 2D pattern.

Evaluating the security of RaS+ with smaller window sizes. We evaluate the security impact of window size in RaS+ using the security metrics against four tested cache side-channel attacks. RaS+Wn is used to denote RaS+ with a window size of n cache lines. For example, RaS+W4 adds a random offset within 4 cache lines (256 bytes) of an authorized address when generating a SHBfetch request.

In the prime-probe attack, where the attacker can get a 2D measurement for each of the 16 input bytes, the score and p-value are computed for each byte and the average score and p-value are reported.

The security metrics of the Baseline system and RaS+ defenses with different window sizes show that the Baseline system is vulnerable to all attacks and has high average Pearson correlation coefficients and low p-values for all attacks. The scores are 0.918 for the prime-probe attack, 0.986 for the flush-reload attack, 0.883 for the evict-time attack, 0.742 for the cache-collision attack and an average of 0.883 for four attacks. The scores of the first two access-based attacks are higher than those of the two operation-based attacks. This clearer timing difference is because measuring the time of an attacker's access has much less noise than measuring the whole AES encryption with many other unrelated accesses by the victim. The average p-value is 0.012, which is less than the commonly used threshold of 0.05 and means the observations are very unlikely to be from non-secret-dependent data.

RaS+W4 has an average score of 0.190. Its average p-value of 0.353 is larger than the 0.05 threshold and means that the attacker's observation is hard to distinguish from an observation generated from non-secret-dependent data. Among all four attacks, the evict-time attack, with the highest score of 0.437 and lowest p-value of 0.147, is the most likely to result in a secret being leaked in RaS+W4. This weaker security guarantee is because, in the eviction phase, there are 8 (the cache associativity) accesses to the same cache set to evict a target cache line of the AES table. With a small window size of 4 and multiple accesses for eviction, the chance of the target cache line still being evicted is higher. The flush-reload attack has a higher score and is more likely to leak a secret than the prime-probe attack in RaS+W4. The higher score is because SHBfetch based on any memory access of the victim can evict the prime-probe attacker's cache lines. However, only SHBfetch based on memory accesses to an AES table can add noise when the attacker reloads and measures the same table.

RaS+W8 has an average score of 0.120 and an average p-value of 0.435, showing better security than RaS+W4, especially against the evict-time attack. The security metrics are similarly good for RaS+W16, RaS+W32 and RaS+W64 with low Pearson correlation coefficients and high p-values, showing that the attacker cannot learn the secret key with these defenses. This saturation in security occurs because each AES table occupies 16 cache lines; thus, security does not significantly improve as long as the window sizes in RaS+W16, RaS+W32 and RaS+W64 are large enough to cover the entire table. In other words, accessing T₁ may result in a random SHBfetch to any of the 16 cache lines of T₁. The same applies to T₂, T₃, and T₄.

### Security Analysis

RaS-Spec with an arbitrary window size can always defeat speculative cache channels as the cache fills by SHBfetch are based on authorized addresses. Similarly, RaS+ never makes speculative cache state changes.

RaS+ decorrelates what memory line is brought in on a cache miss from the demand fetch by adding a random offset within a window. The window size affects RaS+'s security against non-speculative side-channel attacks.

### Impact of Window Size

Contention-based attacks in L1 cache. RaS+ can prevent the contention-based attacks in the set-associative L1 cache by making it equally likely for any cache sets in the window to be evicted and filled. To achieve maximum security by covering all cache sets, the window size can be set to a multiple of the total number of cache sets multiplied by the cache line size. This way, RaS can achieve a randomized L1 cache using a conventional set-associative cache. It gives maximum entropy and uncertainty to the attacker as to which cache set the victim program used.

This hardware-dependent window size has the advantage that the hardware can automatically set the window size for maximum entropy. Software programmers do not have to figure out the security-critical regions to set the window size, and existing software can be protected without modification.

Reuse-based attacks. Non-speculative reuse-based attacks can also be mitigated if the window covers the security-critical region accessed with a secret-dependent index, meaning every cache line in the region has an equal chance of being fetched.

The cache collision attack tries to observe a shorter execution time when the victim will reuse certain secret-dependent addresses in the security-critical region. Having all such addresses equally likely to be fetched will eliminate the timing difference. The flush-reload attacker measures the time it takes to reload each cache line in the region. Noticing a cache hit at a random address in the region will still give no information. In both cases, the attacker cannot recover the secret value.

If the security-critical region is larger than the window size, random fetches within the window can protect the lower bits of an address covered by the window but cannot provide absolute security.

Flexibility about window configuration. Randomly fetching an address near a previously accessed address can improve performance if a program has a good spatial locality. While there is a requirement for window size for security, the window could be shifted in different ways by adjusting the lower bound. For example, the lower bound can be set to the exact SHB address for forward prefetching, or set to

$$( SHB address - \frac{WindowSize}{2} )$$

for adjacent prefetching. In our RaS implementations, the lower bound is set to be the lower bound of the WindowSize-aligned region that contains the selected SHB address (formally defined in the following equation).

$$LowerBound = Addr - ( Addr mod WindowSize )$$

Security-performance trade-offs. A large window size may degrade the likelihood of a future cache hit on the selected line fetched since temporal and spatial locality may be lost across this wide window. Conceptually, a smaller window has better performance than a larger one, which is shown later.

### Other Cache-Related Attacks

While reuse-based and contention-based attacks are the most critical cache timing attacks, we discuss the security and potential modifications to mitigate other related attacks.

Speculative Interference Attacks. In speculative interference attacks, speculative instructions change microarchitectural states and affect the timing of non-speculative instructions that are earlier in program order (older) but execute later than the speculative instructions. For instance, if a speculative instruction executes earlier and keeps a specific functional unit busy, an older instruction of the same type can be delayed due to resource contention. The attacker essentially leverages backward-in-time interference and detects the speculative microarchitectural state change with the older instructions. Speculative interference attacks can exploit cache evictions or fills.

To exploit speculative cache fills, the first type of attack evicts the cache line, which the older instruction will use, with the speculative cache line. This contention-type interference will increase the execution time of the older instruction. The second type of attack is speculatively fetching the cache line the older instruction will use. This reuse-type interference will shorten the execution time of the older instruction. RaS defenses already defend against these attacks because no speculative cache fill can happen.

As a part of the cache, the MSHR can cause similar attacks. If speculative accesses take all available MSHRs, the older instruction will be delayed due to MSHR contention. In another case, if a speculative load to the same address as the older memory instruction has a cache miss and gets an MSHR, the older memory instruction that executes later will reuse this MSHR and have a shorter access time. The simplest solution is to delay sending speculative memory requests until all previous memory instructions have their addresses resolved. An alternative is to use a GhostMinion type defense to allow the older instruction to take over an MSHR.

Speculative cache coherence state change. A speculative load can leak secret information by changing the exclusive state of a cache line in another private cache to a shared state. In a MESI coherence system example, this can be a transition from a Modified (M) or Exclusive (E) state in a remote cache to a Shared(S) state. In a coherence-based speculative execution attack, the receiver can run on a remote core and prepare a cache line in the M state by writing to it. The sender running on another core requests the same address and changes the cache line to the S state. The receiver then performs another write to the address, and the execution time will be longer to invalidate the copy in the sender's cache before doing the write. As a defense against this attack, the speculative modification from the M state to an S state should not be allowed, and the speculative load needs to re-execute when authorized.

Occupancy-based attacks. The attacker exploiting the cache occupancy channel primes the cache with his cache lines and measures the number of evicted cache lines due to the victim's behavior. The RaS+ defense can add noise to the attacker's observation by decoupling the number of evictions from the victim's accesses by allowing cache fills and evictions only for constant-rate SHBfetches. However, RaS+ cannot completely prevent occupancy-based attacks. For instance, a victim may execute a long or short program depending on the secret value. Even with the constant-rate SHBfetch enabled, there will be more cache evictions for the long program and fewer cache evictions for the short program. Further restrictions on the susceptible victim execution are needed against this attack.

Prefetcher-based attacks. The disclosed RaS defense is a safe prefetching approach. In these examples, it is not combined with other prefetchers.

A number of implementations have been described. Nevertheless, it will be understood that various modifications may be made without departing from the spirit and scope of the disclosure. Accordingly, other implementations are within the scope of the following claims.

1. A cache architecture, comprising:
a safe history buffer (SHB) configured to store safe memory addresses during execution of a program, and generate cache line fetch requests based on the safe memory addresses that are stored in the SHB, each safe memory address being a memory address that is authorized, no longer speculative, or not secret.

2. The cache architecture of claim 1, further comprising a pending memory requests tracker configured to track memory requests, each memory request including a NoFill field.

3. The cache architecture of claim 2, further comprising a cache controller configured to:
prevent cache fills for memory requests where the NoFill field is set,
send data to a processor without filling a cache memory when the NoFill field is set, and fill the cache memory with cache lines retrieved by the cache line fetch requests generated by the SHB.

4. The cache architecture of claim 1, wherein the safe history buffer is further configured to generate a command to clear the NoFill field of a pending memory requests tracker entry when a cache line fetch request from the SHB matches an address of the pending memory requests tracker entry.

5. The cache architecture of claim 4, wherein the command to clear the NoFill field of the pending memory requests tracker entry is propagated to a second cache to clear corresponding NoFill fields in second cache entries.

6. The cache architecture of claim 1, wherein the SHB is configured to randomly select a safe memory address from the stored safe memory addresses.

7. The cache architecture of claim 6, wherein the SHB is configured to generate the cache line fetch request based on a random memory line within a window of memory lines that includes the selected safe memory address.

8. The cache architecture of claim 1, wherein the SHB is configured to generate cache line fetch requests at a constant rate independent of cache miss events.

9. The cache architecture of claim 1, further comprising a reorder buffer (ROB) configured to mark memory instructions as unsafe or safe, wherein the SHB receives safe memory addresses from the ROB only when memory instructions are marked as safe.

10. The cache architecture of claim 1, wherein the cache memory implements a random replacement policy for cache line evictions.

11. A method for operating a secure cache memory system, comprising:
determining if a memory address is a safe memory address;
storing safe memory addresses in a safe history buffer (SHB); and
generating cache line fetch requests based on safe memory addresses stored in the SHB; and
filling a cache memory with cache lines retrieved by the cache line fetch requests.

12. The method of claim 11, further comprising a step of generating a command to clear a NoFill field of a pending memory requests tracker entry together with a fetch request from the SHB.

13. The method of claim 11, wherein the step of generating cache line fetch requests comprises randomly selecting a safe memory address from the SHB.

14. The method of claim 13, wherein the step of generating cache line fetch requests comprises selecting a random memory line within a window of memory lines that includes the selected safe memory address.

15. The method of claim 11, further comprising a step of marking memory instructions as unsafe or safe using a reorder buffer, wherein only safe memory addresses are stored in the SHB.

16. A cache architecture, comprising:
a pending memory requests tracker configured to track memory requests including a NoFill field, where the NoFill field is configured to indicate whether data should be provided to the processor without filling the cache memory.

17. The cache architecture of claim 16, further comprising:
a cache memory; and
a cache controller configured to:
prevent cache fills for memory requests having the NoFill field set;
send data to a processor without filling the cache memory when the NoFill field is set; and
fill the cache memory with cache lines retrieved by the cache line fetch requests generated by a safe history buffer (SHB).

18. The cache architecture of claim 17, wherein for memory store requests where the NoFill field is set, preventing cache fills includes writing stored data to a buffer in the next level of cache together with the NoFill field without filling either cache level.

19. The cache architecture of claim 17, wherein the cache memory includes a writeback buffer configured to temporarily store modified cache lines before the modified cache lines are written to the next level of the memory hierarchy, where the writeback buffer includes a NoFill field configured to prevent writebacks of security-sensitive data from filling cache lines at lower levels of the memory hierarchy.

20. A method for securing a cache memory system, comprising:
receiving a memory request including an address and a NoFill indicator;
determining whether the NoFill indicator is set;
when the NoFill indicator is set, retrieving data from a memory hierarchy and providing the data to a processor without filling a cache memory.

21. The method of claim 20, further comprising a step of generating a command to clear a NoFill field of a pending memory requests tracker entry, and clearing the NoFill indicator of a memory request when a fetch request from the safe history buffer matches the address of the memory request having the NoFill indicator set.
